(19) United States
(12) Patent Application Publication
(10) Pub. No.: US 2025/0243314 A1
(43) Pub. Date: Jul. 31, 2025

(54) MOLDED ARTICLE, ELASTIC BODY, AND STRAIN SENSOR

(71) Applicant: CANON KABUSHIKI KAISHA, Tokyo (JP)

(72) Inventors: NORIFUMI MURANAKA, Kanagawa (JP); MASAHIRO WATANABE, Shizuoka (JP); KANA SATO, Shizuoka (JP); TAKAYUKI HIRATANI, Tokyo (JP)

(21) Appl. No.: 19/181,808

(22) Filed: Apr. 17, 2025

Related U.S. Application Data
(63) Continuation of application No. PCT/JP2023/038259, filed on Oct. 24, 2023.

(30) Foreign Application Priority Data
Oct. 25, 2022 (JP) 2022-170592

(51) Int. Cl. C08G 18/44; C08G 18/08; C08G 18/12; C08G 18/20; C08K 3/04

(52) U.S. Cl. CPC C08G 18/44; C08K 3/04; C08G 18/0876; C08G 18/12; C08G 18/2063; C08K 2201/001

(57) ABSTRACT

A molded article including a polyurethane elastomer and a conductive filler in the polyurethane elastomer, wherein: the polyurethane elastomer has a matrix domain structure, the conductive filler is unevenly distributed in the matrix; a relationship between a parameter A indicating a viscoelastic term of the domain and a parameter B indicating a viscoelastic term of the matrix is A<B; the elastic modulus of the molded article is 4 MPa or lower, the elongation at break is 100% or higher, and the tensile permanent strain is 10% or lower; and the change in volume resistivity when 50% stretched is large, and the return rate of the volume resistivity when the tension exerted on the 50% stretched molded article is released is high.

### CROSS-REFERENCE TO RELATED APPLICATION

This is a continuation of International Application No. PCT/JP2023/038259, filed on Oct. 24, 2023, and designated the U.S., and claims priority from Japanese Patent Application No. 2022-170592 filed on Oct. 25, 2022, the entire contents of which are incorporated herein by reference.

### BACKGROUND OF THE INVENTION

### Field of the Invention

The present disclosure relates to a molded article including a urethane elastomer for use in sensors and the like. The present disclosure relates to a molded article that can be used for a resistance-variable sensor or the like, in which volume resistivity varies due to strain. In addition, the present disclosure also relates to an elastic body that can be used in a resistance-variable sensor whose volume resistivity varies due to strain.

### Description of the Related Art

The use of an electrically conductive elastomeric material (conductive elastomer) has been proposed in the application of a sensor to detect the deformation of a member and the stress acting on the member. Conductive elastomers in such applications are required to have flexibility (low elasticity) depending on their deformation range, as well as having repeatability. Japanese Patent Application Publication No. 2007-225315 discloses a composite for a sensor formed by combining a polymer matrix having a phase-separated structure formed using a blend of a plurality of polymers having different elastic moduli and conductive particles.

### SUMMARY OF THE INVENTION

According to the studies of the inventors, although the sensor composite according to Japanese Patent Application Publication No. 2007-225315 has flexibility, there is room for improvement in terms of restitution from deformation, that is, deformation (permanent set) caused by the loading and unloading of an external force, and reproducibility regarding conductivity varying with deformation.

At least one aspect of the present disclosure is directed to the provision of a molded article having low elasticity, low permanent set, and electrical resistance with high repeatability to deformation. Also, at least one aspect of the present disclosure is directed to providing an elastic body that has low elasticity, has little permanent set, and of which a volume resistivity changes stably depending on an amount of strain.

Also, at least one aspect of the present disclosure is directed to providing a strain sensor capable of stably detecting the amount of strain over a long period of time.

At least one aspect of the present disclosure provides a molded article comprising:
a polyurethane elastomer; and
a conductive filler in the polyurethane elastomer, wherein
   the polyurethane elastomer has a matrix and a plurality of domains dispersed in the matrix,
   the conductive filler is localized in the matrix,
   a relationship between a parameter A indicating a viscoelastic term of the domain and a parameter B indicating a viscoelastic term of the matrix, which are measured in a viscoelastic image by a scanning probe microscope of a cross section of the molded article where the domain and the matrix are exposed, is A<B,
   an elastic modulus of the molded article at 50% tension at a temperature of 23° C. is 4.00 MPa or less, a breaking elongation of the molded article is 100% or more, and a tensile permanent set of the molded article after 50% tension is 10% or less, and
   when a volume resistivity of the molded article with no strain is Ra (Ω·cm), a volume resistivity when the molded article is elongated by 50% is Rb (Ω·cm), and a volume resistivity when the tension applied to the molded article elongated by 50% is released is Rc (Ω·cm),
   Ra, Rb, and Rc satisfy Formulas (1) and (2) below:

$${Log}_{10} ( Rb ) - {Log}_{10} ( Ra ) \geq 0.1 \qquad ( 1 )$$

$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

At least one aspect of the present disclosure provides an elastic body comprising:
a polyurethane elastomer; and
a conductive filler in the polyurethane elastomer, wherein
   the polyurethane elastomer has a matrix and a plurality of domains dispersed in the matrix,
   the conductive filler is localized in the matrix,
   a relationship between a parameter A indicating a viscoelastic term of the domain and a parameter B indicating a viscoelastic term of the matrix, which are measured in a viscoelastic image by a scanning probe microscope of a cross section of the elastic body where the domain and the matrix are exposed, is A<B,
   an elastic modulus of the elastic body at 50% tension at a temperature of 23° C. is 4.00 MPa or less, a breaking elongation of the elastic body is 100% or more, and a tensile permanent set of the elastic body after 50% tension is 10% or less, and
   when a volume resistivity of the elastic body in no strain is Ra (Ω·cm), a volume resistivity when the elastic body is elongated by 50% is Rb (Ω·cm), and a volume resistivity when the tension applied to the elastic body elongated by 50% is released is Rc (Ω·cm),
   Ra, Rb, and Rc satisfy Formulas (1) and (2) below:

$${Log}_{10} ( Rb ) - {Log}_{10} ( Ra ) \geq 0.1 \qquad ( 1 )$$

$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

At least one aspect of the present disclosure provides a strain sensor having a strain-sensitive portion whose volume resistivity varies depending on an amount of strain, wherein the strain-sensitive portion comprises a molded article comprising:
a polyurethane elastomer; and
a conductive filler in the polyurethane elastomer, wherein
   the polyurethane elastomer has a matrix and a plurality of domains dispersed in the matrix,
   the conductive filler is localized in the matrix,
   a relationship between a parameter A indicating a viscoelastic term of the domain and a parameter B indicating a viscoelastic term of the matrix, which are measured in a viscoelastic image by a scanning probe microscope of a cross section of the molded article where the domain and the matrix are exposed, is A<B,
   an elastic modulus of the molded article at 50% tension at a temperature of 23°° C. is 4.00 MPa or less, a breaking elongation of the molded article is 100% or more, and a tensile permanent set of the molded article after 50% tension is 10% or less, and
   when a volume resistivity of the molded article with no strain is Ra (Ω·cm), a volume resistivity when the molded article is elongated by 50% is Rb (Ω·cm), and a volume resistivity when the tension applied to the molded article elongated by 50% is released is Rc (Ω·cm),
   Ra, Rb, and Rc satisfy Formulas (1) and (2) below:

$${Log}_{10} ( Rb ) - {Log}_{10} ( Ra ) \geq 0.1 \qquad ( 1 )$$

$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

At least one aspect of the present disclosure can provide a molded article having low elasticity, low permanent set, and electrical resistance with high repeatability to deformation. Also, at least one aspect of the present disclosure can provide an elastic body that has low elasticity, has little permanent set, and of which a volume resistivity changes stably depending on an amount of strain. Also, at least one aspect of the present disclosure can provide a strain sensor capable of stably detecting the amount of strain over a long period of time.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an example of a molded article according to an aspect of the present disclosure.

FIG. 2 is a diagram illustrating a method of manufacturing a molded article according to an aspect of the present disclosure.

FIG. 3 is a schematic view of a resistance measuring tool used for evaluation.

### DESCRIPTION OF THE EMBODIMENTS

In the present disclosure, the expression “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined.

Embodiments of the present disclosure will be described below. Note that the embodiments described below are merely examples, and the present disclosure is not limited to these embodiments, unless otherwise specified.

Also, a resistance according to the present disclosure refers to an electrical resistance unless otherwise described.

### Molded Article Containing Polyurethane Elastomer

The molded article of a polyurethane elastomer according to one aspect of the present disclosure satisfies Requirements (1-1) to (1-4) below:

Requirement (1-1): A molded article including a polyurethane elastomer and a conductive filler in the polyurethane elastomer, the polyurethane elastomer having a matrix and a plurality of domains dispersed in the matrix. The conductive filler is present at least in the matrix.

Requirement (1-2): A relationship between a parameter A indicating a viscoelastic term of the domain and a parameter B indicating a viscoelastic term of the matrix, which are measured in a viscoelastic image by a scanning probe microscope of a cross section where the domain and the matrix are exposed, is A<B.

Requirement (1-3): An elastic modulus of the molded article at 50% tension at a temperature of 23° C. is 4.00 MPa or less, a breaking elongation of the molded article is 100% or more, and a tensile permanent set of the molded article after 50% tension is 10% or less.

Requirement (1-4): The volume resistivity of the molded article with no strain is Ra (Ω·cm), the volume resistivity when the molded article is elongated by 50% is Rb (Ω·cm), and the volume resistivity when the tension applied to the molded article elongated by 50% is released is Rc (Ω·cm). At this time, Ra, Rb, and Rc satisfy Formulas (1) and (2) below:

$${Log}_{10} ( Rb ) - {Log}_{10} ( Ra ) \geq 0.1 \qquad ( 1 )$$

$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

When the molded article in the present disclosure satisfies Requirements (1-1) and (1-2), it is possible to obtain a molded article of a urethane elastomer having low elasticity, low permanent set, and repeatability regarding electrical resistance in resistance to deformation. In addition, by satisfying Requirements (1-3) and (1-4), change in electrical resistance in response to deformation with high repeatability is exhibited, and sufficient performance can be obtained when the sensor is used as a strain sensor.

Hereinafter, requirements for obtaining a molded article having low elasticity, low permanent set, and conductivity will be described in more detail. According to the studies of the inventors, in order to obtain a molded article having low elasticity, small compression set, and conductivity, some problems were present.

The first is the study of substrates to reduce the permanent set while maintaining low elastic modulus. Low elasticity and low permanent set have basically trade-off relationships, and compatibility is difficult.

The second is to achieve both low elasticity and low permanent set even if a conductive filler to be added to the substrate is added. Although it is necessary to add a conductive filler to the substrate for conductivity, the addition of the conductive filler increases the elastic modulus and increases the permanent set. In addition to this effect, it is necessary to achieve both low elasticity and low permanent set.

To solve such a problem, the inventors have made additional studies. As a result, it has been found that, for the first issue, it is effective to use a polyurethane elastomer as a substrate, which has introduced a matrix domain structure having a matrix having a structure capable of achieving low permanent set and a domain having a structure contributing to suppression of an increase in elastic modulus.

Also, it has been found that, if the second issue, the conductive filler is effectively localized in the matrix of the matrix domain structure described above, this enables to be exhibited when adding as small an amount of a conductive filler as possible.

That is, it has been found that the conductive filler preferentially forms the conductive path in the matrix, which allows conductivity to be developed with a small amount, so that it is possible to minimize the increase in elastic modulus and permanent set due to the addition of the conductive filler.

It has been also found that if a certain amount or more of the conductive filler is mixed into the domain, the function of reducing elasticity of the domain is likely to be lost.

From the above studies, it has been found that for a polyurethane elastomer substrate having a matrix with a structure capable of achieving low permanent set and a domain having a structure that contributes to suppressing an increase in elastic modulus, distributing a small amount of conductive filler unevenly in the matrix is effective in simultaneously achieving low elasticity, low permanent set, and electrical conductivity.

Furthermore, by the studies of the inventors, the configuration in which conductive particles are localized in the matrix of the matrix domain structure that can achieve low elasticity, low permanent set, and conductivity at the same time has a change in conductivity with respect to deformation, and electrical resistance with high repeatability to deformation.

In a configuration with a large permanent set, the state of the conductive paths formed by deformation to impart conductivity also irreversibly changes like the strain, thus generating hysteresis not only in shape but also conductivity.

By adopting the above configuration with low permanent set, the restitution of the conductive path against repeated deformation can be ensured. Also, the configuration in which the conductive filler is preferentially distributed in the matrix is likely to have a limited conductive path, and has a wide range of change in conductivity with respect to deformation, and it is considered that the placement of the conductive agent in the highly elastic matrix is less likely to change before and after stress loading and unloading due to deformation.

A molded article according to one aspect of the present disclosure contains a polyurethane elastomer and a conductive filler contained in the polyurethane elastomer.

A polyurethane elastomer, a conductive filler, and a molded article will be described in detail below by way of preferred embodiments.

### Polyurethane Elastomer

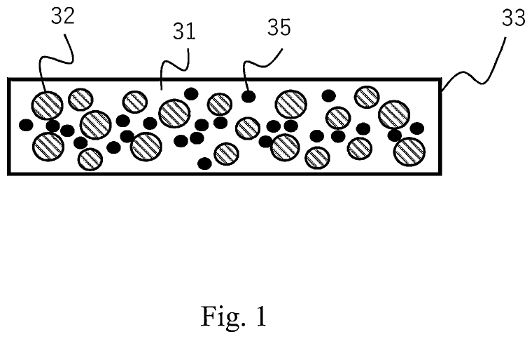

A polyurethane elastomer forming a molded article will be described. FIG. 1 is a schematic cross-sectional view illustrating an example of a molded article 33. As mentioned above, the polyurethane elastomer has a matrix domain structure having a matrix 31 and a plurality of domains 32 dispersed in the matrix. The conductive filler 35 is localized in the matrix 31.

The matrix 31 has a structure showing mechanical properties such as low permanent set, and the domain 32 has a structure contributing to suppression of increase in elastic modulus. At least a portion of the outer surface of the molded article may be composed of a matrix, provided that the polyurethane elastomer forms a matrix domain structure. For example, all of the outer surfaces of the molded article may be composed of a matrix.

There are no particular limitations on the matrix 31 of such a polyurethane elastomer as long as those for a parameter B indicating the viscoelastic term are satisfied. Examples of the matrix 31 include a matrix having a polycarbonate structure or a polyester structure.

The matrix preferably has a polycarbonate structure represented by Formula (1) as a first structure. Furthermore, the alkylene group having 3 to 9 carbon atoms represented by R¹ in the first structure represented by Formula (1) more preferably has a branched structure.

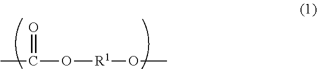

(In Formula (1), R¹ represents an alkylene group having 3 to 9 carbon atoms.)

In general, the polyurethane obtained by the reaction of a polyol having a polycarbonate structure (polycarbonate polyol) with a polyisocyanate exhibits a high elasticity due to strong intermolecular forces between carbonate groups. For this reason, the matrix 31 is preferred as a component.

Since R¹ is an alkylene group having 3 to 9 carbon atoms, incompatibility with a domain containing a polyether having a structure represented by Formula (2) described later is ensured, and the matrix and the domain can be phase-separated more clearly. This may ensure that the two functions of the polyurethane elastomer according to the present disclosure are soft and low permanent set.

The matrix preferably has at least one polycarbonate structure represented by Formula (1), and more preferably has a plurality of polycarbonate structures. In a case where the matrix has a plurality of polycarbonate structures represented by Formula (1), the polycarbonate structure can be a repeating structural unit.

Furthermore, when R¹ is an alkylene group having a branched structure and 3 to 9 carbon atoms, the intermolecular force between the carbonate groups is appropriately suppressed, and the matrix can be prevented from becoming excessively high in elasticity.

Examples of R¹ include —(CH₂)ₘ-(m=3 to 9 (preferably 3 to 6)), —CH₂C(CH₃)₂CH₂—, —CH₂CH(CH₃)CH₂—, and —(CH₂)₂CH(CH₃)(CH₂)₂—. In the polyurethane elastomer, all R¹s may be the same or a combination of different R¹s.

The number average molecular weight of polyols and the like described later, including the number average molecular weight of the polycarbonate structure, can be calculated by the following formula using the hydroxyl value (mgKOH/g) and the valence. For example, the number average molecular weight of a polyether polyol having a hydroxyl value of 56.1 mgKOH/g and a valence of 2 can be calculated as 2000.

Number average molecular weight=56.1×1000×valency/hydroxyl value

The elastic modulus of the matrix can be adjusted, for example, by a method of increasing the crosslinking density using a trimerized or multimeric compound of a polyisocyanate. Although the micro rubber hardness of the molded article is usually increased as the elastic modulus is increased, excessive high elasticity can be suppressed because a plurality of low elastic domains are dispersed in the matrix in the present disclosure.

In the molded article, the elastic modulus of the domains is designed to be lower than that of the matrix. The structure of the domains is not particularly limited as long as they meet the above-described elastic modulus relationship and can form domains phase-separated with the matrix. Preferably, the domain includes a second structure different from the first structure. The second structure preferably includes a polyether structure represented by Formula (2) below.

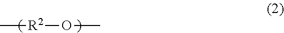

(In Formula (2), R² represents an alkylene group having 3 to 6 carbon atoms.)

Generally, polyethers exhibit low elastic modulus due to weak intermolecular forces between ether groups, so they are preferred as components of domains.

Preferably, R² is an alkylene group having 3 to 5 carbon atoms, and more preferably, R² is an alkylene group having a branched structure and having 3 to 5 carbon atoms. By containing an alkylene group having 3 to 5 carbon atoms, incompatibility with the urethane elastomer having the polycarbonate structure represented by Formula (1) is ensured, and the phase separation between the matrix and the domains is more clearly achieved.

The domain preferably has at least one polyether structure represented by Formula (2), and more preferably has a plurality of polyether structures. In a case where the domain has a plurality of polyether structures represented by Formula (2), the polyether structure can be a repeating structural unit.

Examples of R² include —(CH₂)ₘ- (m=3 to 6 (preferably 3 to 5)), —CH₂CH(CH₃)—, —CH₂C(CH₃)₂CH₂—, —CH₂CH(CH₃)CH₂—, and —(CH₂)₂CH(CH₃)CH₂—. In the polyurethane elastomer, all R²s may be the same or a combination of different R²s.

The number average molecular weight (Mn) of the polyether structure represented by Formula (2) is preferably from 1000 to 50,000 as a repeating unit in the polyurethane elastomer. The number average molecular weight is based on the raw material polyether polyol. The number average molecular weight is more preferably from 1200 to 30,000.

In a case where the number average molecular weight is 1000 or more, the incompatibility with the urethane elastomer containing the polycarbonate structural unit represented by Formula (1) is likely to be secured, and the phase separation of the matrix and the domain is more clarified. Also, in a case where the number average molecular weight is 50,000 or less, domains are more likely to be formed and the phase separation forms are more stabilized.

The total proportion of the cross-sectional area of the domains can be adjusted, for example, by the compounding ratio of the polycarbonate structure of Formula (1) and the polyether structure of Formula (2) of the domains in the matrix. Increasing the compounding ratio of the polyether structural units of Formula (2) increases the total ratio of the cross-sectional areas of the domains. However, if the compounding ratio of the polyether structure of Formula (2) is too high, the matrix and domain reversal may occur, and the polyether structure of Formula (2) may become the main component of the matrix. Also, the cross-sectional area of the domain can be increased, for example, if the number average molecular weight of the polyether structure of Formula (2) is increased.

The chemical structure of the components contained in the matrix and the domain can be analyzed using, for example, a spectroscopic analyzer such as a microinfrared spectroscopic analyzer, or a mass spectrometer.

In the polyurethane elastomer, as described above, the elastic modulus of the domain including the polyurethane including the second structure is designed to be lower than the elastic modulus of the matrix. Specifically, a parameter indicating a viscoelastic term of the domain, which is measured in a viscoelastic image of a cross section in which the domain and the matrix are exposed by a scanning probe microscope, is defined as a parameter A, and a parameter indicating a viscoelastic term of the matrix is defined as a parameter B. At this time, the parameters A and B satisfy A<B.

The difference in the relative elastic modulus of the matrix and domains in the polyurethane elastomer can be measured by observing the flaked polyurethane elastomer with a scanning probe microscope (SPM/AFM). As the scanning probe microscope, “S-Image” (product name), manufactured by Hitachi High-Tech Corporation, can be used.

Examples of the apparatus for thinning include a sharp razor, a microtome, a focused ion beam method (FIB), and the like. Among the above apparatuses, ultramicrotoms capable of preparing ultra-thin slices can be used particularly suitably. A total of three slices were prepared, a 50 μm square observation region was selected, and the viscoelastic image was observed in three observation regions in total.

A viscoelastic dynamic force mode (VE-DFM) shall be used as a measurement mode for the viscoelastic images with the SPM. As a cantilever, a silicon microcantilever for DFM (“SI-DF3” (trade name) manufactured by Hitachi High-Tech Corporation, spring constant: 1.9 N/m) is used. Furthermore, the scanning frequency is set to 0.5 Hz.

The VE-DFM (viscoelastic DFM) is a mode of measuring viscoelasticity distributions at the same time when obtaining images of the surface profile while controlling the distance between a probe and a sample so that the vibration amplitude of the cantilever in a resonating state is fixed. In the VE-DFM, the viscoelasticity distribution is imaged from the deflection amplitude of the cantilever when the sample is micro-vibrated in the Z direction to apply periodic force. When the sample is hard, the amplitude of the cantilever increases because of a minor deformation of the sample; and when the sample is soft, the deformation vibration of the sample is induced, and the amplitude of the cantilever decreases.

The obtained amplitude is converted in terms of mV as a displacement, which is the parameter indicating the viscoelastic term. Accordingly, the parameters A and B are the indexes showing the relationship of hardness between the domains and the matrix that are present in one of the samples. It is noted that in the VF-DFM, the magnitude of the amplitude of the cantilever is outputted as a voltage, and thus, the units of the parameters A and B are mV. In addition, a larger value of the parameter shows higher elasticity.

After the viscoelastic images are obtained, ten parameters indicating the viscoelastic terms of the matrix, and ten parameters indicating those of the domains are obtained from each of the observation regions, and the arithmetic mean values of these parameters of the matrix and the domains shall be used as the parameter A indicating the viscoelastic term of the domains, and the parameter B indicating the viscoelastic term of the matrix. The measurement procedures will be described later.

The value (A/B) of the ratio of the parameter A to the parameter B is preferably 0.65 or less. It is more preferably 0.05 to 0.40, still more preferably 0.05 to 0.30, and still more preferably 0.05 to 0.20. The smaller A/B is, the larger the difference in viscoelasticity between the matrix and the domain, making it easier to achieve both hardness and recovery from deformation.

The parameters A and B can be adjusted by, for example, the elasticity moduli of the domains and the matrix. The elasticity modulus of the matrix can be increased, for example, by using a trimer compound or a multimer compound of a polyisocyanate as a raw material for forming the matrix to increase the crosslink density of the matrix. The elasticity modulus of the domains is decreased by, for example, increasing the molecular weight of the polyether polyol as the raw material for forming the domains to decrease the crosslink density of the domains.

The cross-sectional area and number of the domains 32 of the polyurethane elastomer observed in the cross-section of the molded article will be described.

When observed with 50 μm square observation regions at three locations of the cross-section of the molded article, it is preferable that all three locations of the observation regions satisfy Requirements (2-1) and (2-2) below:

Requirement (2-1): The proportion of the total cross-sectional area of the domains in the observation region is 15% to 45%.

Requirement (2-2): When the cross-sectional area of each domain existing in the observation region is calculated, the proportion of the number of domains whose cross-sectional area is 0.1% to 13.0% of the area of the observation region is 70% by number or more of all domains.

With respect to Requirement (2-1) above, by setting the proportion of the total cross-sectional area of the domain to the area of the observation region to 15% or more, the elastic modulus of the molded article can be suppressed low. Further, by setting the proportion to 45% or less, permanent set of the molded article can be further reduced. The proportion is more preferably 20% to 40%, even more preferably 25% to 35%.

With respect to Requirement (2-2), the number of domains having a cross-sectional area of 0.1% to 13.0% of the area of the observation region is set to 70% or more of the total number of domains in the observation region, thereby ensuring the number of domains having a size enough to deform when the molded article is pressed against pressure. Therefore, the elastic modulus of the molded article can be reduced. Further, since the number of large domains which are excessively deformed when a load is applied to the molded article is small, the micro rubber hardness of the molded article can be suppressed from becoming too low. The measurement will be described later.

The proportion of the number of the domains is more preferably 80% to 95%, and still more preferably 85% to 92%.

The proportion of the number of domains having a cross-sectional area of 0.1 to 13.0 area % relative to the area of the observation region can be adjusted by the size of the cross-sectional area of the domains. As the size of the cross-sectional area of the domain approaches the center of the scope of the requirement, the percentage of the number of domains of the requirement increases. The size of the cross-sectional area of the domain can be adjusted by the number average molecular weight of the polyether polyol forming the polyether structure represented by Formula (2), as described above, and the larger the number average molecular weight of the polyether polyol, the larger the size of the cross-sectional area of the domain. In addition, if the isocyanate index in the process of obtaining the first urethane prepolymer described below is increased or the shear force in mixing the materials is increased, the cross-sectional area of the domains is decreased.

The area ratio of the matrix to domain (matrix/domain) is preferably 55/45 to 85/15. The ratio is more preferably 60/40 to 80/20, still more preferably 65/45 to 75/25. In a case where the area ratio of domains is 45% or less, the phase separation forms are stabilized and matrices and domains are more stably formed. Also, in a case where the area ratio of the domain is 15% or more, it becomes easier to achieve both low elasticity and conductivity.

The area ratio may be controlled by the amount of material of the domain and material of the matrix used.

The area ratio of the matrix/domain is calculated from the cross-sectional image of the urethane elastomer obtained using a scanning electron microscope. More specifically, the following will be described below.

The chemical structures of the components contained in the matrix and the domains can be analyzed using, for example, a spectrometer such as an AFM infrared spectrometer, a microinfrared spectrometer, and a micro-Raman spectrometer, or a mass spectrometer.

Further, the proportion of the number of domains having a circularity of 0.60 to 0.95 in the total number of the domains is preferably 70% by number or more when the three 50 um square observation regions are put on the cross section of the molded product and observed. This proportion is more preferably 80% by number to 99% by number, and further preferably 85% by number to 95% by number.

When domains having a circularity within the above range recover from deformation, the anisotropy in the direction where the shapes of the domains recover is less likely created. The number (proportion) of domains having a circularity within the above range being large, the anisotropy is much less likely created upon recovery from deformation. In other words, the molded product can be configured in such a manner that recovery from deformation thereof is more isotropic. As a result, creases, distortion, etc. due to anisotropy in recovery from deformation are less likely formed after the recovery from the deformation.

The proportion of the numbers can be adjusted, for example, by the rate of injecting the material into a mold. As the injection rate is decreased, the shearing force applied to the material is also decreased, and the material can be heat-set while high circularity is maintained.

### Conductive Filler

The conductive fillers are added for the purpose of conductivity. The conductive filler is, for example, conductive particles. However, in general, the addition of a conductive filler to an elastomeric material causes significant increased elastic modulus and increased permanent set. On the other hand, in the molded article according to the present disclosure, the conductive fillers are localized in the matrix to form conductive paths, and contamination of the conductive fillers into the domains is suppressed as much as possible.

This allows for the molded article according to the present disclosure to provide conductivity with a small amount of conductive filler as compared to a uniform material that does not have a normal matrix domain structure. Therefore, low permanent set and low elasticity can be realized simultaneously with the addition of the conductive filler.

The conductive filler can be used without any particular limitation as long as exhibiting conductivity. Examples of the conductive filler include: solid carbons such as carbon black, graphite, carbon nanotubes, fullerene, graphene, and carbon nanowalls; powders of metals such as silver, copper, aluminum, nickel, and iron; conductive metal oxides such as conductive tin oxides, and conductive titanium oxides; and inorganic ionic materials such as lithium perchlorate, sodium perchlorate, and calcium perchlorate. One of them may be used alone, or two or more of them may be used in combination.

Among them, from the viewpoint that conductivity can be imparted by addition in a small amount, solid carbons such as carbon black, graphite, carbon nanotubes, fullerene, graphene, and carbon nanowalls are preferable. More preferably, conductive carbon black such as furnace black, thermal black, acetylene black, Ketjenblack, PAN (polyacrylonitrile)-based carbon, and pitch-based carbon is preferable because resistance is easily adjusted in a desired range by suitably selecting the particle size, the structure, etc. The conductive filler is preferably the carbon nanotube.

As a conductive carbon black as used herein, DENKA BLACK manufactured by Denka Company Limited, Ketjenblack Series manufactured by Lion Corporation, NIPex 160 IQ manufactured by Orion Engineered Carbons GmbH, etc. are preferable. Examples of Ketjenblack Series as used herein include Ketjenblack EC600JD, Ketjenblack EC300J, carbon ECP, and carbon ECP600JD.

Percolation theory can describe the mechanism for exhibiting conductivity caused by the conductive filler, and there are the following tendencies: when the filling rate of the conductive filler is low, electroconductivity does not change; but when the filling rate thereof exceeds a certain critical filling rate, the conductive filler forms conduction paths aligning at predetermined intervals or less to lead to a sudden rise in electroconductivity (drop in volume resistivity), and thereafter, the electroconductivity reaches a constant value.

In addition, an ionic conducting agent may also be used in the molded article in addition to the conductive filler to adjust the electrical resistance. The ionic conducting agents are not particularly limited, and known ionic conducting agents can be used.

In the molded article according to the present disclosure, the conductive filler is localized in the matrix. Specifically, the total area of the conductive filler per 50 μm×50 μm observation region observed in a cross-section in which the domains and the matrix are exposed is defined as a content C. In addition, the total area of the conductive filler contained in the matrix in the observation region of 50 μm×50 μm is a content D. The value D/C of the ratio of the content D to the content C is D/C≥0.90.

In a case where D/C≥0.90 is satisfied, the influence of functional inhibition due to low elasticity caused by incorporation of the conductive filler into the domain is reduced, making it possible to achieve both low elasticity and electrical resistance with high repeatability against deformation. The upper limit is not particularly limited, but D/C≤1.00 is preferable.

D/C can be increased by, for example, increasing the dispersibility of the conductive filler and the material of the matrix to be used. In addition, for example, D/C can be reduced by increasing the dispersibility of the conductive filler and the material of the domains to be used. Specifically, D/C can be increased by reducing the amount of the hydrophilic functional groups on the surface of the conductive filler. For example, D/C is easily increased, for example, by decreasing the carboxy groups of carbon black so that the hydrophobicity of the surface of the conductive filler is close to that of the matrix. D/C can be reduced by increasing the amount of the hydrophilic functional groups on the surface of the conductive filler.

The method of measuring the contents C and D of the conductive filler will be described later.

The content of the conductive filler in the molded article is preferably 0.02 to 5.0 mass % based on the mass of the molded article. In a case where the content of the conductive filler is 0.02 mass % or more, it becomes easy to impart conductivity more suitable as a sensor to the molded article. In addition, in a case where the content of the conductive filler is 5.0 mass % or less, compatibility of low elasticity and low permanent set more suitable as a sensor while maintaining conductivity is facilitated.

The content of the conductive filler is more preferably 0.05 to 4.5 mass %, still more preferably 0.1 to 3.0 mass %, and still more preferably 1.0 to 3.0 mass %.

Specifically, when the conductive filler is carbon black having a specific surface area of less than 500 m²/g (e.g., DENKA BLACK manufactured by Denka Company Limited), the content thereof is preferably 1.0 to 4.5 mass %, and more preferably 1.5 to 4.0 mass %. When the conductive filler is carbon black having a specific surface area of 500 m²/g or more (e.g., Ketjenblack Series manufactured by Lion Corporation), the content thereof is preferably 0.2 to 4.0 mass %, and more preferably 0.5 to 3.5 mass %. When the conductive filler is a tube-shaped carbon fiber (carbon nanotube) or a needle-shaped carbon fiber (carbon nanofiber) (e.g., a single wall carbon nanotube (TUBALL (registered trademark)) manufactured by OCSiAl) having a specific surface area of 500 m² or more, the content thereof is preferably 0.05 to 3.0 mass %, and more preferably 0.1 to 2.5 mass %.

When the conductive filler is a solid carbon, the content thereof can be calculated using a thermogravimetry/differential thermal analyzer (TG-DTA).

Specifically, the measurement is performed according to the following procedures.

Using TG-DTA, the temperature of a sample that is put in a predetermined vessel is raised to 600° C. at the temperature rising rate of 10° C./min in a nitrogen atmosphere, held for 10 min, and thereafter, cooled to 400° C. at the cooling rate of 10° C./min, and the weight loss W1 (%) from the start of the measurement is measured. Then, the temperature of the sample is raised again to 800° C. at the temperature rising rate of 10° C./min in an air atmosphere, and the weight loss W2 (%) from the start of the measurement is measured. The content of the conductive filler (solid carbon) can be calculated as the difference between W2 and W1 (W2-W1 (%)).

### Molded Article

The molded article according to the present disclosure has the following resistance range. The volume resistivity of the molded article with no strain is Ra (Ω·cm), the volume resistivity when the molded article is elongated by 50% is Rb (Ω·cm), and the volume resistivity when the tension applied when the molded article is elongated by 50% is released is Rc (Ω·cm). At this time, Ra, Rb, and Rc satisfy Formulas (1) and (2) below:

$${Log}_{10} ( Rb ) - {Log}_{10} ( Ra ) \geq 0.1 \qquad ( 1 )$$

$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

The left side of Formula (1) represents the resistance change during deformation (during load), and if this value is large, the sensitivity as the sensor increases. In a case where Log₁₀(Rb)-Log₁₀(Ra) is less than 0.10, the sensitivity of conductivity to deformation is low, which is not suitable as a sensor. Also, it is preferably 1.00 or more. Log₁₀(Rb)-Log₁₀(Ra) is preferred as large and the upper limit is not particularly limited, preferably 3.00 or less, more preferably 2.00 or less.

Log₁₀(Rb)-Log₁₀(Ra) can be varied depending on the amount of conductive filler and the presence of conductive filler. The conductive filler can be increased by localized distribution of the matrix (by increasing the D/C ratio). In particular, in a case where the amount of conductive filler is relatively small and Ra is large, the amount of conductive filler can be increased.

Formula (2) represents the ratio of the resistance variation during deformation (during load) to the resistance variation during unloading, that is, the return rate of the resistance to the resistance variation during deformation. In a case where the value of the left side of Formula (2) exceeds 0.25, the resistance reproducibility is low and it is not suitable as a sensor with respect to resistance variations during deformation. The value of the left side of Formula (2) is preferably 0.10 or less, more preferably 0.05 or less, and within this range is more suitable as a sensor. The lower the value of the left side in Formula (2) is preferred, so the lower limit is not particularly limited, and is preferably equal to or greater than 0.00.

The value of the left side of Formula (2) can be reduced by reducing the compression set of the polymer containing the conductive filler.

Further, Ra preferably satisfies Formula (3) below. This indicates that the volume resistivity of the molded article is 1.00×10⁹ Ω·cm or less. This makes it easier to measure volume resistivity with high accuracy, which is suitable as a sensor.

Log₁₀(Ra) is more preferably 8.20 or less, and still more preferably 7.20 or less. The lower limit is not particularly limited, but is preferably 2.00 or more, 3.00 or more, 5.00 or more.

$${Log}_{10} ( Ra ) \leq 9. \qquad ( 3 )$$

The value of Logo (Ra) on the left side of Formula (3) can be controlled by the amount of the conductive filler and the presence state of the conductive filler.

In the molded article, Ra and Rc preferably satisfy Formula (4) below.

$${Log}_{10} ( Rc ) - {Log}_{10} ( Ra ) \leq 0.05 \qquad ( 4 )$$

Formula (4) represents the return rate of the resistance when the load is applied and the load is removed. Since the value of the left side in Formula (4) is 0.05 or less, it is more suitable as a sensor because of good reproducibility of resistance. The value of the left side of Formula (4) is more preferably 0.04 or less. The lower the value of the left side in Formula (4) is preferred, and the lower limit is not particularly limited, but is preferably equal to or greater than 0.00.

The value of the left side of Formula (4) can be reduced by reducing the compression set of the matrix and the domain containing the conductive filler. In addition, the value of the left side of Formula (4) can be reduced by positively disposing the conductive filler in a highly elastic matrix.

Note that the volume resistivities Ra, Rb, and Rc can be measured using a KEITHLEY6517. Specific means will be described later.

Further, when the volume resistivity is measured between two electrodes, for example, the volume resistivity in a case where the molded article is elongated by 50%, the volume resistivity may be measured in a state where the length between the electrodes is pulled 1.5 times.

The elastic modulus of the molded article at 50% tension at a temperature of 23° C. is 4.00 MPa or less. The elastic modulus of 4.00 MPa or less can flexibly deform against external forces such as tension.

The elastic modulus at 50% tension is preferably 0.10 to 1.00 MPa, more preferably 0.30 to 0.80 MPa, and even more preferably 0.40 to 0.60 MPa. The elastic modulus can be measured by performing a tension test on a universal testing machine (manufactured by ORIENTEC CO., LTD., product name: TENSILON RTF-1250). Specific means will be described later.

The elastic modulus value at 50% tension can be controlled by the elastic modulus of the domain polymer and the elastic modulus of the matrix polymer, and their ratios.

The breaking elongation of the molded article at a temperature of 23° C. is 100% or more. Within the above range, sufficient strength can be obtained as a molded article against large tensile deformation and large bending deformation. The breaking elongation of the molded article can be controlled by the elastic modulus of the domain polymer or the matrix polymer or the volume ratio between the domain and the matrix. For example, the lower the elastic modulus of domains and matrices, the more the breaking elongation is likely.

The tensile permanent set of the molded article after 50% tensile at a temperature of 23° C. is 10% or less. Within the above range, sufficient repeated deformation characteristics can be obtained for tensile deformation and bending deformation. The permanent set of the molded article can be adjusted by the elastic modulus of the matrix. For example, when the crosslinking density is increased using a trimer compound or a multimer compound of polyisocyanate, the elastic modulus of the matrix is increased. As will be described later, when the matrix and the domain are chemically bonded, the elastic modulus of the matrix is easily increased by the means, and the tensile permanent set is easily set within the above range.

In the molded article, preferably the matrix, which is the segment composed of the first structure, and the domain, which is the segment composed of the second structure, are phase separated. The two segments are present almost without being compatible with each other. Such a clear phase separation prevents the inclusion of the segments composed of the second structure into the matrix. This makes it easier for the matrix to achieve low permanent set in the molded article.

The micro rubber hardness of the molded article at a temperature of 23° C. is preferably 20 to 50 degrees, and more preferably 25 to 35 degrees. Then, a Vickers indenter is brought into contact with the matrix of a cross section where the domain and the matrix are exposed, the Vickers indenter is pushed in at a load rate of 10 mN/30 seconds, and maintained at a load of 10 mN for 60 seconds, and unloading the load. The strain after 5 seconds from unloading is preferably 1.0 μm or less. By satisfying these requirements, a molded article exhibiting a fast recovery rate while having flexibility even against local deformation can be obtained.

In the molded article according to the present disclosure, it is preferable that the domains and the matrix are chemically bonded by a urethane bond at the boundary portion between the domains and the matrix. Therefore, it is considered that recovery from deformation of the domains when the load applied to the urethane elastomer is removed will interlock with recovery from deformation of the matrix. Accordingly, it is considered that the molded article according to the present disclosure has an extremely high recovery from deformation and is liable to have strain after 5 seconds of unloading within the above range.

The micro rubber hardness can be adjusted, for example, by the elastic modulus of the matrix, the amount of conductive filler contained in the matrix, the proportion of the matrix to domains, and the like. Specifically, for example, increasing the elastic modulus of the matrix, increasing the proportion of conductive fillers included in the matrix, and reducing the proportion (volume) of domains to the matrix acts in a direction to increase the micro rubber hardness.

In addition, the strain after 5 seconds of unloading can also be adjusted by the elastic modulus of the matrix. For example, when the crosslinking density is increased using a trimer compound or a multimer compound of polyisocyanate, the elastic modulus of the matrix is increased. When the matrix and the domain are chemically bound, the means facilitates increasing the elastic modulus of the matrix and allows strain after 5 seconds of unloading to fall within the above range.

The molded product according to the present disclosure is not particularly limited, but can be synthesized, for example, by the method including the following steps (i) to (iii):
step (i): reacting the first urethane prepolymer having at least one (preferably at least two) isocyanate group(s) with the first polycarbonate polyol having at least two hydroxyl groups to obtain the second urethane prepolymer having at least two hydroxyl groups;
step (ii): mixing the second urethane prepolymer, the conductive filler, and the second polycarbonate polyol (which may be an unreacted excess of the first polycarbonate polyol) to obtain a dispersion formed by dispersing droplets containing at least part of the second urethane prepolymer throughout the second polycarbonate polyol containing the conductive filler; and
step (iii): preparing a mixture for forming the molded product which contains: the dispersion; and a polyisocyanate having at least two isocyanate groups, and then, reacting the second urethane prepolymer, the second polycarbonate polyol, and the polyisocyanate which are in the mixture to form the molded product of the polyurethane elastomer.

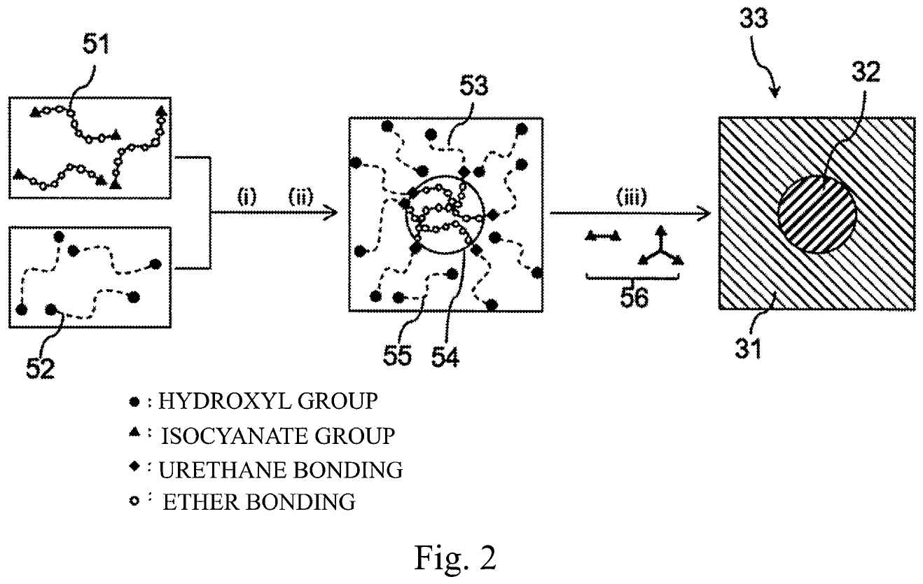

One embodiment of the aforementioned method of producing the molded product according to one aspect of the present disclosure will be described with reference to the FIG. 2 (not showing the conductive filler). The method of producing the molded product according to the present disclosure is not limited to this embodiment.

In the step (i), a first urethane prepolymer 51 having at least one (preferably at least two) isocyanate group(s), and a first polycarbonate polyol 52 having at least two hydroxyl groups are mixed. Next, the isocyanate group(s) and the hydroxyl groups in the obtained mixture are reacted in the presence of a curing catalyst to link both kinds of groups via urethane bonds whereby a second urethane prepolymer 53 having at least two hydroxyl groups is obtained.

In the FIG. 2, a polyether having two isocyanate groups is shown as an example of the first urethane prepolymer 51. An example of the first urethane prepolymer 51 is a urethane prepolymer having the second structure, and a preferred example thereof is a reaction product of a polyol and a polyisocyanate, such as a polyether diol.

In the step (ii), a dispersion formed by dispersing droplets containing at least part of the second urethane prepolymer throughout the second polycarbonate polyol containing the conductive filler is obtained. Here, the second urethane prepolymer can be mixed with the second polycarbonate polyol, which is newly added in this step. The unreacted excess of the first polycarbonate polyol in the step (i) can also be used as the second polycarbonate polyol.

The first urethane prepolymer 51 contained in the second urethane prepolymer 53 is not miscible with the second polycarbonate polyol 55, but forms droplets 54.

On the contrary, the first polycarbonate polyol 52 contained in the second urethane prepolymer 53 is miscible with the second polycarbonate polyol 55. Thus, the droplets 54 containing the first urethane prepolymer 51 which constitutes part of the second urethane prepolymer 53 are uniformly and stably dispersed throughout the second polycarbonate polyol 55 via the first polycarbonate polyol 52. As a result, the dispersion formed by dispersing the droplets 54 containing the first urethane prepolymer 51 (second structure) throughout the second polycarbonate polyol 55 is obtained.

In order to disperse the conductive filler throughout the matrix, the conductive filler may be dispersed throughout the second polycarbonate polyol 55 in advance before the step (ii). In the step (ii), the conductive filler is preferably dispersed throughout the second polycarbonate polyol 55. In the second urethane prepolymer formed in the step (i), the interfaces are formed by the urethane bonds of the droplets 54, which can be the domains later, and the conductive filler is difficult to enter the droplets 54.

Alternatively, between the steps (ii) and (iii), the conductive filler may be added. The conductive filler is well dispersed throughout the matrix. Because the interfaces between the matrix and the domains are rigidly formed via the chemical bonds (urethane bonds), a large amount of the conductive filler does not enter the domains even when the conductive filler is added and stirred after the step (ii).

For description, the steps (i) and (ii) are separately described, but these steps may be a series of successive steps.

In the step (ii), the second polycarbonate polyol 55 where the droplets 54 are dispersed may be an unreacted excess of the first polycarbonate polyol used in the step (i) that is not reacted with the first urethane prepolymer. That is, in the step (i), an excessive amount of the first polycarbonate polyol is used for the first urethane prepolymer whereby the dispersion, described in the step (ii), formed by dispersing the second urethane prepolymer 53 throughout excess of the first polycarbonate polyol (that is, the second polycarbonate polyol 55) can be obtained.

Even when an excessive amount of the first polycarbonate polyol is used, the polycarbonate polyol (second polycarbonate polyol) as a dispersion medium for the second urethane prepolymer may be added additionally. In this case, the chemical composition of the additional polycarbonate polyol may be the same or different from that of the first polycarbonate polyol used in the step (i).

On the contrary, when equivalent amounts of the first polycarbonate polyol and the first urethane prepolymer are reacted in the step (i), and all the first polycarbonate polyol has been consumed, a new polycarbonate polyol is used as the second polycarbonate polyol in the step (ii) to prepare the dispersion. Also in this case, the chemical composition of the polycarbonate polyol used as the second polycarbonate polyol may be the same or different from that of the first polycarbonate polyol.

Finally, in the step (iii), a mixture for forming the molded product that contains: the dispersion prepared in the step (ii); and a polyisocyanate 56 having at least two isocyanate groups is prepared. Then, the terminal hydroxyl groups of the second urethane prepolymer 53, the hydroxyl groups of the second polycarbonate polyol 55, and the isocyanate groups of the polyisocyanate 56 which are in the mixture are reacted.

Thus, a network structure via urethane bonds is formed, and the mixture for forming the molded product is cured to obtain the molded product according to the present disclosure. A molded product 33 that is obtained in such a manner has a matrix-domain structure formed by dispersing domains 32 each having a structure derived from the first urethane prepolymer 51, i.e., the second structure throughout a matrix 31 containing a urethane elastomer having a polycarbonate structure derived from the first polycarbonate polyol 52 and the second polycarbonate polyol 55, i.e., the first structure.

Further, the molded product 33 contains the conductive filler, and the conductive filler is predominantly distributed in the matrix 31. The domains 32 are each mainly composed of the second structure, and the insides of the domains can be configured to have substantially no cross-linked structure. In other words, the domains 32 can be configured to be present in the matrix in an almost liquid state. This allows the domains to have a low elasticity modulus in the molded product 33 according to the present disclosure.

Furthermore, not just the liquid portion of the domains is enclosed in the matrix, but the domains and the matrix are chemically bonded via urethane bonds at the boundaries between the domains and the matrix. Therefore, recovery of domains from the deformation when the load applied to the molded product 33 is removed can be linked with recovery of the matrix from the deformation.

That is, the domains almost in the form of liquid substantially have no cross-linked structure, for example, thereinside. Therefore, it is difficult that domains that deform due to the application of a load to the molded product 33 autonomously recover from the deformation. However, in the molded product according to the present disclosure, the domains and the matrix are chemically bonded (urethane-bonded) at the boundaries between the domains and the matrix whereby the domains can recover from the deformation together with recovery of the matrix from the deformation. According to this, stable deformation (deformation amount) and stable recovery from the deformation can be achieved even when loads are repeatedly applied to and removed from the molded product 33.

The above steps (i) and (ii) are the steps of stably dispersing the polyol having the second structure which is originally low in miscibility and difficult to be stably and uniformly dispersed throughout a polyol having the first structure. That is, the first urethane prepolymer 51 is reacted with the first polycarbonate polyol 52 to form the second urethane prepolymer 53.

This makes it possible to obtain the dispersion formed by stably and uniformly dispersing the segment of the polyol derived from the first urethane prepolymer 51 throughout the second polycarbonate polyol. This makes it easy to produce the molded product 33 which is formed by dispersing the domains 32, which have a high circularity, a small size of the order of magnitude of micrometers, and a relatively uniform size distribution, throughout the matrix 31.

An example of other methods of mixing materials that are low miscible with each other is a mixing and dispersing method with high shearing force. However, according to this method, high shearing force is applied to the polyol having the second structure, and as a result, the shapes of the domains deform to reduce the circularity, and the sizes of the domains may also be nonuniform. In addition, the dispersion state is unstable, and the agglomeration of the domains progresses in a relatively short time.

Further, the non-miscibility of the polyol having the second structure with the polyol having the first structure is not ensured, and the phase separation of the matrix from the domains in the resulting polyurethane elastomer becomes unclear. Therefore, it is difficult to obtain the molded product according to the present disclosure, which can provide a flexible elastic body excellent in recoverability from deformation.

The amounts of the uses of the polyol having the second structure and the polyol having the first structure are not particularly limited, and may be amounts that allows the droplets 54 to be dispersed throughout the second polycarbonate polyol 55 to form clear domains. For example, the polyol having the second structure: the polyol having the first structure is, on the basis of the mass, preferably 10:90 to 50:50, and more preferably 20:80 to 40:60.

The first urethane prepolymer has at least one isocyanate group, and has the second structure; and preferably, has at least one isocyanate group, and the polyether structure having the structure represented by the formula (2). The first urethane prepolymer can be obtained, for example, by the following steps:
a polyether polyol having at least two hydroxyl groups, and having the structure represented by the formula (2) is reacted with the polyisocyanate having at least two isocyanate groups.

Examples of the polyether polyol include: alkylene structure-containing polyether-based polyols such as polypropylene glycol, polytetramethylene glycol, copolymers of tetrahydrofuran and neopentyl glycol, and copolymers of tetrahydrofuran and 3-methyltetrahydrofuran; and random or block copolymers of these polyalkylene glycols. One of them may be used alone, or two or more of them may be used in combination.

Among the polyether polyols, amorphous polyether polyols are preferable from the viewpoint on probable achievement in low miscibility with the second polycarbonate polyol described later, and low elasticity. More preferably, among the polyether polyols, at least one selected from polypropylene glycol, copolymers of tetrahydrofuran and neopentyl glycol, and copolymers of tetrahydrofuran and 3-methyltetrahydrofuran is contained. Further preferably, at least polypropylene glycol is contained.

The number average molecular weight of the polyol having the second structure is preferably from 1000 to 50000. More preferably, this number average molecular weight is from 1200 to 30000. When the number average molecular weight is 1000 or more, low miscibility with the polycarbonate polyol is ensured, and the phase separation of the matrix from the domains in the resulting urethane elastomer is more clarified. When the number average molecular weight is 50000 or less, the polyurethane segment derived from the polyether polyol tends to easily form the domains, and the phase-separated morphology is more stabilized.

Examples of the polyisocyanate to be reacted with the polyol having the second structure include: pentamethylene diisocyanate; hexamethylene diisocyanate; isophorone diisocyanate; 2,4-tolylene diisocyanate; 2,6-tolylene diisocyanate; xylylene diisocyanate; diphenylmethane diisocyanate; trimer compounds (isocyanurates) or multimer compounds of these polyisocyanates; allophanate-type polyisocyanates; buuret-type polyisocyanates; and water-dispersible polyisocyanates. One of these polyisocyanates may be used alone, or two or more of them may be used in combination.

Among the above-exemplified polyisocyanates, a bifunctional isocyanate (diisocyanate) having two isocyanate groups is preferable because of high miscibility with the polyol having the second structure, and easiness in adjustment of physical properties such as viscosity. More preferably, among the aforementioned polyisocyanates, at least one selected from hexamethylene diisocyanate, isophorone diisocyanate, 2,4-tolylene diisocyanate, 2,6-tolylene diisocyanate, xylylene diisocyanate, and diphenylmethane diisocyanate is contained. Xylylene diisocyanate is further preferable.

In the step of reacting the polyol having the second structure with the polyisocyanate to obtain the first urethane prepolymer, the isocyanate index is preferably 0.05 to 8.0. This isocyanate index is more preferably 0.1 to 5.0. The isocyanate index within this range can lead to reduction of components derived from the first urethane prepolymer that are not in the network structure and remain, and suppress liquid materials oozing from the polyurethane elastomer.

The isocyanate index indicates the ratio ([NCO]/[OH]) of the number of moles of the isocyanate groups in the isocyanate compound to the number of moles of the hydroxyl groups in the polyol compound.

The first urethane prepolymer obtained by the reaction of the polyol having the second structure with the polyisocyanate has a linking structure via the urethane bonds by the reaction of the hydroxyl groups with the isocyanate groups. The number average molecular weight of the first urethane prepolymer is preferably from 1000 to 100,000. This number average molecular weight is more preferably from 1200 to 50000.

The first polycarbonate polyol is a polycarbonate polyol having at least two hydroxyl groups, and having the structure represented by the formula (1); and is preferably a polycarbonate diol having the structure represented by the formula (1). Examples of the first polycarbonate polyol include reaction products of a polyhydric alcohol with phosgene, and ring-opened polymers of cyclic carbonates (such as alkylene carbonates).

Examples of polyhydric alcohols as used herein include propylene glycol, dipropylene glycol, trimethylene glycol, 1,4-tetramethylene diol, 1,3-tetramethylene diol, 2-methyl-1,3-trimethylene diol, 1,5-pentamethylene diol, neopentyl glycol, 1,6-hexamethylene diol, 3-methyl-1,5-pentamethylene diol, 2,4-diethyl-1,5-pentamethylene diol, glycerin, trimethylol propane, trimethylolethane, cyclohexanediols (such as 1,4-cyclohexanediol), and sugar alcohols (such as xylitol and sorbitol).

Examples of alkylene carbonates as used herein include trimethylene carbonate, tetramethylene carbonate, and hexamethylene carbonate.

The number average molecular weight of the first polycarbonate polyol is preferably from 500 to 10000, and more preferably from 700 to 8000. When this number average molecular weight is 500 or more, low miscibility with the polyurethane segments having the polyether structures represented by the formula (2) is ensured, and the phase separation of the matrix from the domains can be more clarified. When this number average molecular weight is 10000 or less, increase in viscosity of the polycarbonate polyol as the raw material prevents handling from being difficult, which is preferable.

The number average molecular weight of the first polycarbonate polyol can be calculated using hydroxyl values (mgKOH/g) and valences as well as the number average molecular weight of the polyether polyol.

As the polyisocyanate 56 having at least two isocyanate groups which are used in the step (iii), the same one as any of the polyisocyanates exemplified above as the raw material for the first urethane prepolymer can be used. One of these polyisocyanates may be used alone, or two or more of them may be used in combination.

As the polyisocyanates used in the step (iii), a polyisocyanate having at least three isocyanate groups, such as trimer compounds (isocyanurates) or multimer compounds of polyisocyanates, allophanate-type polyisocyanates, and buuret-type polyisocyanates among the above-exemplified polyisocyanates, is preferably contained in the viewpoint of improving the elastic modulus of the matrix.

More preferably, at least one selected from the group consisting of a trimer compound of pentamethylene diisocyanate (isocyanurate), a trimer compound of hexamethylene diisocyanate (isocyanurate), a multimer compound of diphenylmethane diisocyanate, and polymeric MDI can be used. Curing catalysts for urethane elastomers are roughly classified into a urethanization catalyst (reaction-promoting catalyst) for promoting rubberization (resinification) and foaming, and an isocyanuratization catalyst (isocyanate trimerization catalyst). In the present disclosure, one of them may be used alone, or they may be mixed to be used.

Among the foregoing, polymeric MDI is preferable. Here, polymeric MDI is a mixture of a monomeric MDI and a high molecular weight polyisocyanate, and is represented by the following formula (A). In the formula (A), n is preferably from 0 to 4.

Commercially available polymeric MDI may be used, and examples thereof include Millionate MR series (manufactured by Tosoh Corporation) including Millionate MR200 (trade name).

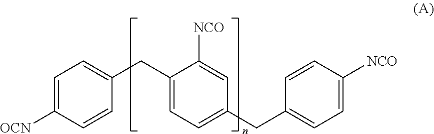

As the polyisocyanate 56 having at least two isocyanate groups, a polyisocyanate having at least three isocyanate groups, such as polymeric MDI, and a bifunctional isocyanate having two isocyanate groups are preferably used in combination. The foregoing use in combination allows the crosslink density to be controlled, and thus, is preferable from the viewpoint on achievement in both low elasticity and low permanent set.

The amounts of the polyisocyanate having at least three isocyanate groups, and the bifunctional isocyanate having two isocyanate groups are not particularly limited. As the amounts in mixing in the dispersion in the step (iii), the bifunctional isocyanate:the polyisocyanate having at least three isocyanate groups is preferably 3:1 to 1:10, and more preferably 1:1 to 1:6. The amount of the polyisocyanate to 100 parts by mass of the dispersion in the step (iii) is also not particularly limited, and examples of thereof include 1 to 10 parts by mass, and 3 to 8 parts by mass.

Examples of a urethanization catalyst as used herein include: tin-based urethanization catalysts such as dibutyltin dilaurate, and stannous octoate; and amine-based urethanization catalysts such as triethylenediamine, tetramethylguanidine, pentamethyldiethylenetriamine, diethylimidazole, tetramethylpropanediamine, N,N,N′-trimethylaminoethylethanolamine, and 1,4-diazabicyclo[2.2.2]octane-2-methanol. One of them may be used alone, and they may be mixed to be used. Among these urethanization catalysts, triethylenediamine, and 1,4-diazabicyclo[2.2.2]octane-2-methanol are preferable in view of particularly promoting the urethane reaction.

Examples of isocyanuratization catalysts as used herein include: metal oxides such as Li₂O, and (Bu₃Sn)₂O; hydride compounds such as NaBH₄; alkoxide compounds such as NaOCH₃, KO-(t-Bu), and borates; amine compounds such as N(C₂H₅)₃, N(CH₃)₂CH₂C₂H₅, and 1,4-ethylene piperazine (DABCO); alkaline carboxylate salt compounds such as HCOONa, Na₂CO₃, PhCOONa/DMF, CH₃COOK, (CH₃COO)₂Ca, alkaline soaps, and naphthenates; alkaline formate compounds; and quaternary ammonium salt compounds such as ((R)₃—NR′OH)—OCOR″.

Examples of combination catalysts (cocatalysts) that can be used as the isocyanuratization catalyst include amine/epoxide, amine/carboxylic acid, and amine/alkyleneimide. One of these isocyanuratization catalysts and combination catalysts may be used alone, or they may be mixed to be used.

As a catalyst for urethane synthesis, N,N,N′-trimethylaminoethylethanolamine (hereinafter referred to as ETA), which operates alone as a urethanization catalyst, and also operates as an isocyanuratization catalyst may be used.

In the method of producing the polyurethane elastomer, a chain extender (polyfunctional low-molecular weight polyol) may be used if necessary. Examples of the chain extender include glycols having number average molecular weights of 1000 or less.

Examples of a glycol as used herein include ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexanedimethanol, xylylene glycol (terephthalyl alcohol), and triethylene glycol.

Examples of a chain extender other than glycols as used herein include polyhydric alcohols with trivalent or higher. Examples of a polyhydric alcohol with trivalent or higher as used herein include trimethylolpropane, glycerin, pentaerythritol, and sorbitol. One of them may be used alone, or they may be mixed to be used.

If necessary, additives such as a conducting agent, a pigment, a plasticizer, a waterproofing agent, an antioxidant, an ultraviolet light absorbing agent, and a light stabilizer may also be used in combination.

The molded article can be used as a molded article of a urethane elastomer for a sensor. For example, the molded article can be used for a resistance change type sensor or the like in which volume resistance varies due to strain.

Specifically, according to an aspect of the present disclosure, a strain sensor is provided that has a strain-sensitive portion whose volume resistivity changes according to an amount of strain, the strain-sensitive portion including a molded article according to an aspect of the present disclosure. Such strain sensors may have high sensitivity to slight strains because the strain-sensitive portion is flexible. Further, since the strain-sensitive portion is less likely to generate permanent set even by repeated strain loads and unloads, it is possible to accurately detect strain even by repeated use.

### EXAMPLES

One aspect of the present disclosure will be further specifically described below with reference to the examples. However, the present disclosure is not limited to the following examples.

### Example 1

### (Preparation of Mixture for Forming Molded Article)

20.1 parts by mass of polypropylene glycol (product name: PREMINOL S 4013F, manufactured by AGC Inc.), 19.2 parts by mass of polypropylene glycol (product name: UNIOL D-4000, manufactured by NOF CORPORATION), and 2.6 parts by mass of xylylene diisocyanate (XDI) (manufactured by Tokyo Chemical Industry Co., Ltd.) were mixed with 500 ppm of 1,4-diazabicyclo[2.2.2]octane-2-methanol (product name: RZETA, manufactured by Tosoh Corporation) as a curing catalyst, and the mixture was stirred for 4 hours in a closed mixer adjusted to 100° C. to synthesize a polyether having two isocyanate groups (first urethane prepolymer).

Note that, including the following examples and comparative examples, the amount of the curing catalyst is ppm by mass based on the mass of the total material used for the molded article.

50.4 parts by mass of polycarbonate diol (product name: DURANOL G3452, manufactured by Asahi Kasei Corporation) was mixed therewith. Thereafter, the mixture was stirred for an additional 2 hours in a sealed mixer adjusted to 100° C. to synthesize a urethane reactive emulsifier (second urethane prepolymer) having two hydroxyl groups, and to obtain a dispersion in which droplets containing the urethane reactive emulsifier were dispersed in a polycarbonate diol (Process (i)).

1.5 parts by mass of carbon black (product name: DENKA BLACK powder, manufactured by Denka Company Limited.) was added to this dispersion and stirred for 3 minutes at a revolution speed of 1600 rpm using a rotation-revolution type vacuum defoaming mixer to obtain a dispersion in which the carbon black was dispersed.

(Process (ii))

Next, 1.1 parts by mass of xylylene diisocyanate (sometimes referred to as “XDI” hereinafter, manufactured by Tokyo Chemical Industries, Inc.) and 5.3 parts by mass of a polyisocyanate (product name: MILLIONATE MR-200, manufactured by Tosoh Corporation, which may be described as “MR-200”) were added to a dispersion in which the carbon black was dispersed and stirred for 2 minutes in a rotation-revolution type vacuum defoaming mixer under conditions of a revolution speed of 1,600 rpm to obtain a mixture for forming the molded article.

### (Preparation of Molded Article)

The mixture for forming a molded article was poured into a mold for producing a 2 mm thick sheet preheated to 130° C. over 10 seconds, and held at 130° C. for 2 hours to be cured (Process (iii)). Next, the cured product was demolded and aged at 80° C. for 2 days to obtain a molded article. Further, the obtained molded article was evaluated as follows.

### Evaluation

Evaluation methods in examples and comparative examples are as follows.

### (Evaluation 1: Confirmation and Analysis of Matrixes (in Tables 5-1, 5-2, 6-1, 6-2, 7-1 and 7-2, It May Be Described as “M”) and Domains (in Tables 5-1, 5-2, 6-1, 6-2, 7-1 and 7-2, It May Be Described as “D”))

Ultrathin slices (500 μm×500 μm×5 μm) were made from a molded product by the use of a freeze fracturing system (trade name: EM FC6, manufactured by Leica Microsystems), and an ultramicrotome (trade name: EM UC6, manufactured by Leica Microsystems). The slices were made at three locations in total: the center; and two locations sufficiently distant from the center at the molded product.

Mapping measurement was conducted on the made slices by the use of an infrared microscope/imaging system (trade names: Spectrum 400 (analyzer), and Spotlight 400 (scanning device), manufactured by PerkinElmer, Inc.) to create mapping images. Concerning the measurement, the mapping measurement was conducted using an ATR imaging accessory under the following conditions: pixel size: 1.56 μm; resolution: 16 cm⁻¹; field of view: 300 μm×300 μm; and scan speed: 1.0 cm/s. On the mapping images, the magnitude of the integrated values of the infrared absorption spectra for respective pixels was imaged.

From each of the resulting mapping images, the presence of a matrix mapped as a continuous phase, and the presence of domains mapped as discontinuous phases were confirmed. Furthermore, from the infrared absorption spectrum of the matrix of each of the mapping images, it was confirmed that the matrix had the first structure (e.g., a structure corresponding to the polycarbonate diol). From the infrared absorption spectra of the domains of the mapping images, it was confirmed that the domains had the second structure (e.g., a structure corresponding to the polypropylene glycol). That is, it was confirmed that the matrix had the carbonate structure represented by the formula (1), and the domains had the ether structure represented by the formula (2).

### (Evaluation 2: Measurement of Parameters Indicating Viscoelastic Terms)

Ultrathin slices were made in the same manner as in evaluation 1.

The number of the made slices was three in total. 50 μm square observation regions were selected, and viscoelastic images were observed in the three observation regions in total. In the three observation regions in total, the viscoelastic images were measured using a scanning probe microscope (trade name: S-Image, manufactured by SII NanoTechnology Inc.). The measurement mode for the viscoelastic images was set in the VE-DFM. For a cantilever, “SI-DF3” (trade name, manufactured by Hitachi High-Tech Corporation, spring constant=1.9 N/m) was used. Furthermore, the scanning frequency was set to 0.5 Hz.

From the obtained viscoelastic images, ten parameters indicating the viscoelastic terms of the matrix, and ten parameters indicating those of the domains were obtained from each of the observation regions, and from the arithmetic mean values of these parameters, the parameter A (mV) indicating the viscoelastic term of the domains, and the parameter B (mV) indicating the viscoelastic term of the matrix were obtained. The evaluation was performed based on the magnitude relationship of the viscoelastic terms.

It is noted that it was confirmed in the viscoelastic images of the SPM that the domains and the matrixes were exposed in the cross sections.

### (Evaluation 3: Presence Position of Conductive Filler (Position of Carbon Black (CB)))

Slices (500 μm×500 μm×100 nm) were manufactured from the molded article using a freeze cutting system (product name: EM FC6, Leica Microsystems) and an ultramicrotome (product name: EM UC6, Leica Microsystems).

On each slice, a square observation region with one side of 50 μm was placed. Then, using a high resolution electron energy loss spectroscopic electron microscope (product name: H-7100FA, manufactured by Hitachi High-Tech Corporation) combining a transmission electron microscope (TEM) and an electron energy loss spectroscopy (EELS) in three observation regions in total, an acceleration voltage of 100 kV, an observation magnification of 3,000 times, under conditions of beam diameter 2 nm, a TEM image of the observation region and a mapping image of oxygen atoms (hereinafter simply referred to as “mapping image”) were obtained.

From the TEM image, it was confirmed that there were matrices and domains in the observation region. Also, in the mapping image, a region that does not contain oxygen atoms, that is, a portion of carbon black (conductive filler) was possible to distinguish from the region of the urethane elastomer. From the TEM image and the mapping image, carbon black present in the matrix and carbon black present in the domain were identified.

Next, the mapping image was then obtained using image processing software (product name: Image-Pro Plus, Media Cybernetics) to obtain a binary image for analysis in which the carbon black portion and the urethane elastomer portion were binary-coded. The threshold value for binarization was determined from the luminance distribution of the mapping image based on Otsu's algorithm described in IEEE Transactions on SYSTEMS, MAN, AND CYBERNETICS, Vol. SMC-9, No. 1, January 1979, pp. 62-66.

Next, from the obtained binary image, the total area of carbon black (conductive filler) present in the observation region is set to the content C using the counting function of the image processing software. The total area of the carbon black (conductive filler) present in the matrix is defined as the content D. Then, a value D/C of the ratio of the content D to the content C is calculated.

In the evaluation of the example, a case where the value D/C of the ratio of the total area (content D) of the conductive filler present in the matrix to the total area (content C) of the conductive filler is 0.90 or more is set as A, and a case where the value is less than 0.90 is set as B. The evaluation results are described as the position of CB in Evaluation 3.

### (Evaluation 4: Measurement of Elastic Modulus)

The universal testing machine (manufactured by ORIENTEC CO., LTD., product name: TENSILON RTF-1250) was used for the molded article, and the tensile stress was measured at 23° C. in accordance with JIS K 6251. The tensile stress at 50% elongation was set to elastic modulus (MPa). Specifically, it is as follows.

The model 2 in dumb-bell shape was used and the pulling rate was 500 mm/min. In addition, the average value of three tests was evaluated.

### (Evaluation 5: Breaking Elongation)

The tensile strength of the molded article was measured according to JIS K 6251 at a temperature of 23° C. using a universal testing machine (manufactured by ORIENTEC CO., LTD., product name: TENSILON RTF-1250). Specifically, it is as follows.

The model 2 in dumb-bell shape was used and the pulling rate was 500 mm/min. In addition, the average value of three tests was evaluated.

The evaluation results are described as breaking elongation of Evaluation 5.

(Evaluation 6: Tensile Permanent Set after 50% Tension)

The tensile strength was measured at a temperature of 23° C. using a universal testing machine (manufactured by ORIENTEC CO., LTD., product name: TENSILON RTF-1250). 50% elongation was applied to the molded article, the molded article was held for 30 seconds, the stress was then released, and the elongation amount after 10 seconds was defined as a permanent set. Specifically, it is as follows.

The model 2 in dumb-bell shape was used and the pulling rate was 500 mm/min. In addition, the average value of three tests was evaluated.

The evaluation result is described as a permanent set in Evaluation 6.

(Evaluation 7: Log₁₀(Rb)-Log₁₀(Ra))

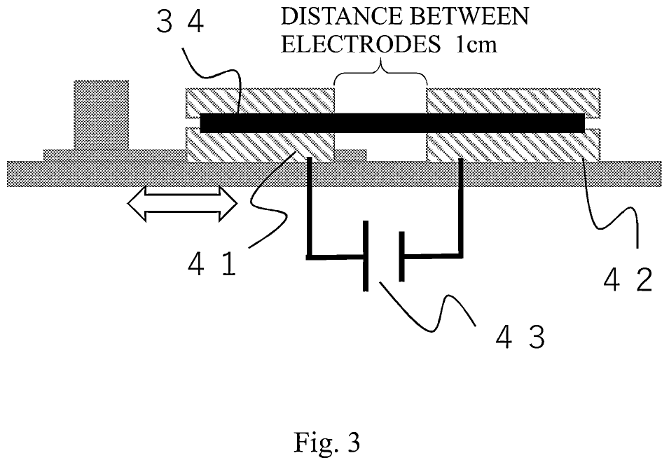

Measurement methods of resistors Ra, Rb, and Rc according to Evaluation 7 to Evaluation 10 will be described. A rectangular (cuboid) sample 34 with a width of 5 mm, length of 40 mm, and thickness of 2 mm was extracted from the molded article and placed on the tool illustrated in FIG. 3. A voltage of 50 V was applied to a power source 43 using KEITHLEY6517, and the resistance after 10 seconds was measured and converted to volume resistivity.

Ra was a value obtained by converting the initial resistance value (under no load) into volume resistivity. In addition, Rb was set to a volume resistivity after 10 seconds by applying a voltage of 50 V 30 seconds after 50% tension. The tension of 50% was performed by moving an electrode 41 on one side to set the distance between the electrodes to 1.5 cm which is 1.5 times. For Rc, 50% tension was held for 30 seconds and after its tensile stress was removed, voltage was applied 50 V and volume resistivity after 10 seconds was used.

For conversion of the volume resistivity, the length between the electrodes and the cross-sectional area at the center of the molded article were measured and used. Measurements were performed at 23° C. The arithmetic average value of 10 samples was adopted.

The value calculated by Log₁₀(Rb)-Log₁₀(Ra) was evaluated as Example 7.

(Evaluation 8: Log₁₀(Rc)-Log₁₀(Ra)/(Log₁₀(Rb)-Log₁₀(Ra)))

According to Evaluation 7, the value calculated by (Log₁₀(Rc)-Log₁₀(Ra))/(Log₁₀(Rb)-Log₁₀(Ra)) was evaluated as Evaluation 8.

### (Evaluation 9: Log₁₀(Ra))

According to Evaluation 7, the value of Logio (Ra) was evaluated as Evaluation 9.

(Evaluation 10: Log₁₀(Rc)-Log₁₀(Ra))

According to Evaluation 7, the value of Log₁₀(Rc)-Log₁₀(Ra) was evaluated as Evaluation 10.

### (Evaluation 11: Micro Rubber Hardness)

The micro rubber hardness of the molded article was measured using a micro rubber hardness meter (product name: MD-1 capa, manufactured by KOBUNSHI KEIKI CO., LTD.). In the measurement, the molded article was left in an environment at a temperature of 23° C. for 24 hours or longer, and the measurement was performed using a measuring device placed in the same environment. In addition, type A (pushing needle shape: height 0.50 mm, diameter 0.16 mm, cylindrical shape, pressing leg dimensions: outer diameter 4 mm, inner diameter 1.5 m) was used as the pressing needle, and the measurement mode was a peak hold mode.

The micro rubber hardness was measured at three points in total, the center of the molded article and two points sufficiently distant from the center. The average value when the micro rubber hardness was measured at each measurement site at a temperature of 23°° C. was calculated.

### (Evaluation 12: Nanoindenter)

Deformation recoverability of the molded article was evaluated by an indentation test using a nanoindenter (product name: HM2000, manufactured by FISCHER INSTRUMENTS K.K.) at a temperature of 23° C. In the measurement, the molded article was left in an environment at a temperature of 23° C. for 24 hours or longer, and the measurement was performed using a measuring device placed in the same environment.

The measurement was performed at a total of three places, that is, the center of the molded article and two places sufficiently away from the center. In the push-in test, a Vickers indenter (Square-shaped, facing angle) 136° is pushed into the matrix of the molded article at a load rate of 10 mN/30 seconds and maintained at a load of 10 mN for 60 seconds. Thereafter, the load was removed (unloading) at an unloading rate of 10 mN/1 second, the strain of the molded article 5 seconds after unloading was measured, and the arithmetic average value measured at each measurement place was calculated.

Whether the indenter pushed the matrix was confirmed by a video micro image attached to the apparatus.

In the evaluation of the example, the case of 1.0 μm or less was set as A, and the case of more than 1.0 μm was set as B.

### (Evaluation 13: Proportion of Cross-sectional Area of Domain)

Each of the three viscoelastic images obtained in Evaluation 2 was converted into a 256-gradation grayscale image using image processing software (product name: Image-Pro Plus, manufactured by Media Cybernetics), and then binarized to obtain a binarized image for analysis. The threshold value for binarization was determined from the luminance distribution of the monochrome image based on Otsu's algorithm described in IEEE Transactions on SYSTEMS, MAN, AND CYBERNETICS, Vol. SMC-9, No. 1, January 1979, pp. 62-66.

Furthermore, from the obtained binarized image, the cross-sectional area of the domain and the number of domains were calculated using the counting function of the image processing software. However, among domains determined to be domains by the counting function, a domain having a cross-sectional area of less than 0.05 area % with respect to a 50 μm square observation region was regarded as noise and deleted from data. Then, the proportion (area %) of the total cross-sectional area of the domains in each observation region to the area of the observation region was calculated.

### (Evaluation 14: Number of Domains)

Similarly to Evaluation 13, a noise-removed binary image was obtained.

Then, the number of domains whose cross-sectional area is 0.1 to 13.0 area % of the area of the observation region among domains in each observation region is obtained, and the proportion (area %) of the number of domains having cross-sectional area of 0.1 to 13.0 area % to the area of the observation region is obtained.

### (Evaluation 15: Circularity)

From the binary image obtained in Evaluation 13, the circularity of the domain was calculated using the counting function of the image processing software described above. However, the noise-derived domains were removed from the data in the same manner as Evaluation 13. Then, the number of domains having a circularity of from 0.60 to 0.95 among domains in each observation region was counted, and the proportion (%) to the total number of domains in each observation region was calculated.

### Examples 2 to 11 and 13

A mixture for forming a molded article was prepared in the same manner as in Example 1 except that the materials shown in Table 4 were used in the blending amounts shown in Table 4. The molded article according to each example was prepared in the same manner as in Example 1 except that the mixture for forming the molded article was used. The obtained molded article was evaluated in the same manner as in Example 1.

Note that the details of the material species in Table 4 are shown in Tables 1, 2 and 3. The same applies to the following examples.

### Example 12

A mixture for forming a molded article was prepared in the same manner as in Example 1 except that the materials shown in Table 4 were used in the blending amounts shown in Table 4. Thereafter, the mixture for forming a molded article was placed on a hot plate preheated to 130° C., quickly stretched by an applicator to have a thickness of 2 mm, and held at 130° C. for 2 hours to be cured. Next, the cured product was aged at 80° C. for 2 days to obtain a molded article. Furthermore, the obtained molded article was evaluated in the same manner as in Example 1.

TABLE 1

| | | Number of carbons of R² in | |
|---|---|---|---|
| Number | Material A | General Formula (2) | Mn |
| A1 | Polypropylene glycol | 3 (Branched) | 12,000 |
| | ┌PREMINOL S4013F┘ | | |
| | (Product name, Manufactured by AGC Inc.) | | |
| A2 | Polypropylene glycol | 3 (Branched) | 4,000 |
| | ┌UNIOL D-4000┘ | | |
| | (Product name, Manufactured by NOF | | |
| | CORPORATION) | | |
| A3 | Polypropylene glycol | 3 (Branched) | 2,000 |
| | ┌UNIOL D-2000┘ | | |
| | (Product name, Manufactured by NOF | | |
| | CORPORATION) | | |
| A4 | Polytetramethylene glycol | 4 (Straight chain) | 2,000 |
| | ┌PTMG2000┘ | | |
| | (Product name, Manufactured by Mitsubishi | | |
| | Chemical Group Corporation) | | |
| A5 | Tetrahydrofuran-neopentyl glycol copolymer | 4 (Straight chain) | 1,800 |
| | ┌PTXG-1800┘ | +5 (Branched) | |
| | (Product name, Manufactured by Asahi Kasei | | |
| | Corporation) | | |

The tetrahydrofuran-neopentyl glycol copolymer of the above A5 is a polyether glycol represented by the structural formula: HO—(CH₂CH₂CH₂CH₂O)ₘ—(CH₂C(CH₃)₂CH₂O)ₙ—.

TABLE 2

| | | Number of carbons of | |
|---|---|---|---|
| Number | Material B | R¹ in General Formula (1) | Mn |
| B1 | Polycarbonate diol | 3 (Straight chain) | 2,000 |
| | ┌DURANOL G3452┘ | +4 (Branched) | |
| | (Product name, Manufactured by Asahi Kasei | | |
| | Corporation) | | |
| B2 | Polycarbonate polyol | 6 (Straight chain) | 2,000 |
| | ┌KURARAY POLYOL C-2090┘ | +6 (Branched) | |
| | (Product name, Manufactured by KURARAY | | |
| | CO., LTD.) | | |
| B3 | Polycarbonate polyol | 9 (Straight chain) | 2,000 |
| | ┌KURARAY POLYOL C-2065N┘ | +9 (Branched) | |
| | (Product name, Manufactured by KURARAY | | |
| | CO., LTD.) | | |
| B4 | Polycarbonate diol | 6 (Straight chain) | 2,000 |
| | ┌DURANOL T6002┘ | | |
| | (Product name, Manufactured by Asahi Kasei | | |
| | Corporation) | | |
| B5 | Polyester polyol | — | 2,000 |
| | ┌KURARAY POLYOL P-2050┘ | | |
| | (Product name, Manufactured by KURARAY | | |
| | CO., LTD.) | | |

With respect to the number of carbon atoms in the table, for example, the description of 6 (straight chain) +6 (branched) indicates that R¹ includes a straight chain structure having 6 carbon atoms and a branched structure having 6 carbon atoms.

KURARAY POLYOL C-2090 (polycarbonate polyol manufactured by KURARAY CO., LTD.; number average molecular weight 1993; hydroxyl value 56.3 mgKOH/g) related to the above B2 is a polycarbonate polyol having a structure derived from 1,6-hexanediol and a structure derived from 3-methyl-1,5-pentanediol.

TABLE 3

| Number | Material C |
|---|---|
| C1 | Carbon black |
| | ┌DENKA BLACK powdery product┘ |
| | (Product name, Manufactured by Denka Company Limited) |
| C2 | Carbon black |
| | ┌NIPex160IQ┘ |
| | (Product name, Manufactured by Orion Engineered Carbons S.A.) |

TABLE 4

| | Material A | | Material A | | Material B | | Material C | | | | | Parts by |
|---|---|---|---|---|---|---|---|---|---|---|---|---|
| Example | | Parts by | | Parts by | | Parts by | | Parts by | Parts by mass of XDI | | | mass of |
| No. | No. | mass | No. | mass | No. | mass | No. | mass | Total | 1st | 2nd | MR-200 |
| 1 | A1 | 20.1 | A2 | 19.2 | B1 | 50.4 | C1 | 1.5 | 3.7 | 2.6 | 1.1 | 5.3 |
| 2 | A2 | 6.2 | A3 | 5.3 | B3 | 75.4 | C1 | 1.5 | 5.0 | 1.7 | 3.3 | 7.1 |
| 3 | A2 | 25.1 | — | — | B2 | 62.8 | C2 | 2.7 | 4.6 | 2.6 | 2.0 | 6.5 |
| 4 | A2 | 25.1 | — | — | B2 | 62.8 | C2 | 2.4 | 4.6 | 2.6 | 2.0 | 6.5 |
| 5 | A5 | 24.7 | — | — | B2 | 61.8 | C1 | 1.7 | 5.7 | 5.5 | 0.2 | 6.7 |
| 6 | A5 | 24.7 | — | — | B2 | 61.8 | C1 | 1.5 | 5.7 | 5.5 | 0.2 | 6.7 |
| 7 | A2 | 25.1 | — | — | B2 | 62.8 | C2 | 2.5 | 4.6 | 2.6 | 2.0 | 6.5 |
| 8 | A2 | 25.1 | — | — | B4 | 62.7 | C1 | 1.5 | 3.4 | 1.9 | 1.5 | 6.5 |
| 9 | A2 | 25.1 | — | — | B2 | 62.8 | C2 | 2.5 | 4.6 | 2.6 | 2.0 | 6.5 |
| 10 | A1 | 44.3 | — | — | B5 | 46.1 | C2 | 2.5 | 3.4 | 1.6 | 1.8 | 4.9 |
| 11 | A3 | 7.0 | — | — | B4 | 79.2 | C2 | 2.5 | 5.3 | 1.5 | 3.8 | 7.4 |
| 12 | A2 | 25.1 | — | — | B2 | 62.8 | C2 | 2.5 | 4.6 | 2.6 | 2.0 | 6.5 |
| 13 | A4 | 24.7 | — | — | B2 | 61.8 | C1 | 1.5 | 5.5 | 5.3 | 0.2 | 6.9 |

With respect to the number of parts by mass of XDI, 1st is the amount used in the preparation of the first urethane prepolymer, and 2nd is the addition amount to the dispersion in which carbon black is dispersed.

### Comparative Example 1

### (Preparation of Mixture for Forming Molded Article)

24.9 parts by mass of polypropylene glycol (product name: PREMINOL S 4013F, manufactured by AGC Inc.), 24.0 parts by mass of polypropylene glycol (product name: UNIOL D-4000, manufactured by NOF CORPORATION), and 3.1 parts by mass of xylylene diisocyanate (XDI) (manufactured by Tokyo Chemical Industry Co., Ltd.) were mixed with 500 ppm of a curing catalyst (product name: RZETA, manufactured by Tosoh Corporation), and the mixture was stirred for 4 hours in a closed mixer adjusted to 100° C. to synthesize a polyether having two isocyanate groups.

41.5 parts by mass of polycarbonate diol (product name: DURANOL G3452, manufactured by Asahi Kasei Corporation) was mixed therewith. Thereafter, the mixture was further stirred for 2 hours with a closed mixer adjusted to 100°° C. to synthesize a urethane reactive emulsifier having 2 hydroxyl groups and obtain a dispersion in which droplets containing the urethane reactive emulsifier were dispersed in polycarbonate diol.

1.8 parts by mass of carbon black (product name: DENKA BLACK powder, manufactured by Denka Company Limited.) was added to this dispersion and stirred for 3 minutes at a revolution speed of 1600 rpm using a rotation-revolution type vacuum defoaming mixer to obtain a dispersion in which the carbon black was dispersed.

Next, 0.3 parts by mass of xylylene diisocyanate (XDI) (manufactured by Tokyo Chemical Industry Co., Ltd.) and 4.9 parts by mass of polyisocyanate (product name: MILLIONATE MR-200, manufactured by Tosoh Corporation) were added to the dispersion in which carbon black was dispersed, and the mixture was stirred for 2 minutes under the condition of a revolution speed of 1600 rpm using a rotation-revolution type vacuum defoaming mixer to obtain a mixture for forming a molded article.

The molded article according to this comparative example was obtained in the same manner as in Example 1 except that the mixture for forming a molded article thus obtained was used. The obtained molded article was evaluated in the same manner as in Example 1.

For the results of Evaluation 1, the matrices and domains were clearly phase separated. In addition, it was confirmed that the matrix contained a urethane elastomer composed of polyether, and the domain contained a urethane elastomer composed of polycarbonate. That is, the relationship between the domain and the matrix was opposite to that of the polyurethane elastomer according to Example 1. This is believed to be because the amount of the polycarbonate diol used to make the molded article was relatively small compared to the amount of the polyether diol, resulting in a change in the phase structure that could be stably present.

### Comparative Example 2

### (Preparation of Mixture for Forming Molded Article)

7.0 parts by mass of polypropylene glycol (product name: UNIOL D-2000, manufactured by NOF CORPORATION) and 79.1 parts by mass of polycarbonate diol (DURANOL T6002, manufactured by Asahi Kasei Corporation) were added with 500 ppm of a curing catalyst (product name: RZETA, manufactured by Tosoh Corporation), and the mixture was stirred for 2 hours in a closed mixer adjusted to 100° C.

Further, 3.0 parts by mass of carbon black (product name: NIPex160IQ, manufactured by Orion Engineered Carbons S.A.) was added, and the mixture was stirred with a rotation-revolution type vacuum defoaming mixer under the condition of a revolution speed of 1600 rpm for 3 minutes.

4.9 parts by mass of xylylene diisocyanate (XDI) (manufactured by Tokyo Chemical Industry Co., Ltd.) and 7.9 parts by mass of polyisocyanate (product name: MILLIONATE MR-200, manufactured by Tosoh Corporation) were added thereto. The obtained mixture was stirred for 2 minutes in a rotation-revolution type vacuum defoaming mixer at a revolution speed of 1,600 rpm to obtain a mixture for forming the molded article.

A molded article was formed in the same manner as in Example 1 except that the mixture for forming a molded article was used, and a molded article according to this comparative example was prepared. The obtained molded article was evaluated in the same manner as in Example 1. In particular, in the results of Evaluation 1, no clear phase separation between the matrix and the domains was observed.

### Comparative Example 3

### (Preparation of Mixture for Forming Molded Article)

46.6 parts by mass of polycarbonate diol (product name: KURARAY POLYOL C-2090, manufactured by KURARAY CO., LTD.) and 44.8 parts by mass of resin particles (product name: TECHPOLYMER MBX-5, manufactured by Sekisui Kasei Co., Ltd.) were added with 500 ppm of a curing catalyst (product name: RZETA, manufactured by Tosoh Corporation), and the mixture was stirred for 4 hours in a closed vacuum mixer adjusted to 100° C.

Further, 1.7 parts by mass of carbon black (product name: DENKA BLACK, manufactured by Denka Company Limited) was added, and the mixture was stirred with a rotation-revolution type vacuum defoaming mixer under the condition of a revolution speed of 1600 rpm for 3 minutes.

2.8 parts by mass of xylylene diisocyanate (XDI) (manufactured by Tokyo Chemical Industry Co., Ltd.) and 4.5 parts by mass of polyisocyanate (product name: MILLIONATE MR-200, manufactured by Tosoh Corporation) were added thereto. The obtained mixture was stirred for 2 minutes in a rotation-revolution type vacuum defoaming mixer at a revolution speed of 1,600 rpm to obtain a mixture for forming the molded article.

A molded article was formed in the same manner as in Example 1 except that the mixture for forming a molded article was used, and a molded article according to this comparative example was prepared. The obtained molded article was evaluated in the same manner as in Example 1. In the evaluation of the molded article according to the present comparative example, the resin particles were evaluated as a domain.

### Comparative Example 4

### (Preparation of Mixture for Forming Molded Article)

20.1 parts by mass of polypropylene glycol (product name: PREMINOL S 4013F, manufactured by AGC Inc.), 19.2 parts by mass of polypropylene glycol (product name: UNIOL D-4000, manufactured by NOF CORPORATION), 2.6 parts by mass of xylylene diisocyanate (XDI) (manufactured by Tokyo Chemical Industry Co., Ltd.), 1.5 parts by mass of carbon black (product name: DENKA BLACK powdery product, manufactured by Denka Company Limited), and 500 ppm of 1,4-diazabicyclo[2.2.2]octane-2-methanol (product name: RZETA, manufactured by Tosoh Corporation) were added thereto as a curing catalyst, and the mixture was stirred for 4 hours with a sealed mixer adjusted to 100° C. to synthesize a polyether having two isocyanate groups.

50.4 parts by mass of polycarbonate diol (product name: DURANOL G3452, manufactured by Asahi Kasei Corporation) was mixed therewith. Thereafter, the mixture was stirred for an additional 2 hours in a sealed mixer adjusted to 100° C. to synthesize a urethane reactive emulsifier (second urethane prepolymer) having two hydroxyl groups, and to obtain a dispersion in which droplets containing the urethane reactive emulsifier were dispersed in a polycarbonate diol.

This dispersion is added with 1.1 parts by mass of xylylene diisocyanate (sometimes referred to as “XDI” hereinafter, manufactured by Tokyo Chemical Industries, Inc.), 5.0 parts by mass of polyisocyanate (trade name: MILLIONATE MR-200, manufactured by Tosoh Corporation, which may be described as “MR-200”), and stirred for 2 minutes in a rotation-revolution type vacuum defoaming mixer under conditions of a revolution speed of 1,600 rpm to obtain a mixture for forming the molded article.

A molded article was formed in the same manner as in Example 1 except that the mixture for forming a molded article was used, and a molded article according to this comparative example was prepared. The obtained molded article was evaluated in the same manner as in Example 1.

The evaluation results are shown in Tables 5-1, 5-2, 6-1, 6-2, 7-1 and 7-2 below.

TABLE 5-1

| | Evaluation 1 | Eval. 2 | | | Eval. 3 | Eval. 4 | Eval. 5 | Eval. 6 |
|---|---|---|---|---|---|---|---|---|
| Example | Confirmation and analysis | Relationship | | | Position | Elastic | Breaking | Permanent |
| No. | of matrixes and domains | of AB | A | B | of CB | modulus | elongation | set |
| 1 | Clear phase separation of M | A < B | 70 | 180 | 0.96 | 0.44 | 180 | 5 |
| | and D | | | | | | | |
| | M: Structure derived from | | | | | | | |
| | polycarbonate urethane | | | | | | | |
| | D: Structure derived from | | | | | | | |
| | PPG | | | | | | | |
| 2 | Same as above | A < B | 110 | 260 | 0.95 | 0.54 | 120 | 3 |
| 3 | Same as above | A < B | 90 | 230 | 0.98 | 0.60 | 140 | 1 |
| 4 | Same as above | A < B | 90 | 230 | 0.97 | 0.58 | 140 | 2 |
| 5 | Clear phase separation of M | A < B | 100 | 230 | 0.96 | 0.60 | 160 | 1 |
| | and D | | | | | | | |
| | M: Structure derived from | | | | | | | |
| | polycarbonate urethane | | | | | | | |
| | D: Structure derived from | | | | | | | |
| | tetrahydrofuran-neopentyl | | | | | | | |
| | glycol copolymer | | | | | | | |
| 6 | Clear phase separation of M | A < B | 100 | 230 | 0.96 | 0.58 | 160 | 2 |
| | and D | | | | | | | |
| | M: Structure derived from | | | | | | | |
| | polycarbonate urethane | | | | | | | |
| | D: Structure derived from | | | | | | | |
| | tetrahydrofuran-neopentyl | | | | | | | |
| | glycol copolymer | | | | | | | |
| 7 | Clear phase separation of M | A < B | 90 | 230 | 0.97 | 0.56 | 150 | 4 |
| | and D | | | | | | | |
| | M: Structure derived from | | | | | | | |
| | polycarbonate urethane | | | | | | | |
| | D: Structure derived from | | | | | | | |
| | PPG | | | | | | | |

TABLE 5-2

| | | | | | | | Eval. 13 | | |
|---|---|---|---|---|---|---|---|---|---|
| | | | | | Eval. 11 | | Domain | Eval. 14 | |
| | Eval. 7 | Eval. 8 | Eval. 9 | Eval. 10 | Micro | Eval. 12 | cross- | Number | |
| Example | Formula | Formula | Formula | Formula | rubber | Nano | sectional | of | Eval. 15 |
| No. | (1) | (2) | (3) | (4) | hardness | indenter | area | domains | Circularity |
| 1 | 1.48 | 0.20 | 7.00 | 0.30 | 22 | 1.0 | 45% | 70% | 90% |
| 2 | 0.18 | 0.12 | 8.00 | 0.02 | 27 | 0.6 | 15% | 70% | 90% |
| 3 | 1.40 | 0.03 | 7.00 | 0.04 | 30 | 0.4 | 30% | 90% | 90% |
| 4 | 0.11 | 0.19 | 8.00 | 0.02 | 29 | 0.5 | 30% | 90% | 90% |
| 5 | 1.54 | 0.03 | 7.30 | 0.04 | 30 | 0.5 | 30% | 90% | 90% |
| 6 | 0.26 | 0.05 | 9.04 | 0.01 | 29 | 0.6 | 30% | 90% | 90% |
| 7 | 1.54 | 0.09 | 7.30 | 0.15 | 28 | 0.7 | 30% | 90% | 90% |

In each table, “Eval.” indicates “Evaluation”, and the relationship of AB indicates the relationship between the parameters A and B indicating the viscoelastic term. The elastic modulus indicates an elastic modulus (MPa) at 50% tension. The breaking elongation is breaking elongation of the molded article (%), and the permanent set is the tensile permanent set of the molded article after 50% tension (%). Evaluations 7 to 10 describe values on the left side of Formulas (1) to (4). The unit of micro rubber hardness is “degree”. The nanoindenter of Evaluation 12 indicates “Strain after 5 seconds of unloading in indentation test using nanoindenter on matrix (μm)”.

Evaluation 13 Domain cross-sectional area indicates “proportion of sum of cross-sectional areas of domains in observation region of 50 μm square”. Evaluation 14 Number of domains is “the proportion of the number of domains whose area is 0.1% to 13.0% of the area of the observation region”. Evaluation 15 Circularity is the “proportion of the number of domains with a circularity of 0.60 to 0.95 to the total number of domains”.

TABLE 6-1

| | Evaluation 1 | Eval. 2 | | | Eval. 3 | Eval. 4 | Eval. 5 | Eval. 6 |
|---|---|---|---|---|---|---|---|---|
| Example | Confirmation and analysis | Relationship | | | Position | Elastic | Breaking | Permanent |
| No. | of matrixes and domains | of AB | A | B | of CB | modulus | elongation | set |
| 8 | Clear phase separation of M | A < B | 50 | 230 | 0.95 | 0.38 | 130 | 6 |
| | and D | | | | | | | |
| | M: Structure derived from | | | | | | | |
| | polycarbonate urethane | | | | | | | |
| | D: Structure derived from | | | | | | | |
| | PPG | | | | | | | |
| 9 | Same as above | A < B | 90 | 230 | 0.97 | 0.60 | 140 | 4 |
| 10 | Clear phase separation of M | A < B | 50 | 140 | 0.96 | 0.42 | 190 | 6 |
| | and D | | | | | | | |
| | M: Structure derived from | | | | | | | |
| | polyester urethane | | | | | | | |
| | D: Structure derived from | | | | | | | |
| | PPG | | | | | | | |
| 11 | Same as above | A < B | 140 | 280 | 0.96 | 0.82 | 130 | 2 |
| 12 | Same as above | A < B | 90 | 230 | 0.96 | 0.60 | 140 | 5 |
| 13 | Clear phase separation of M | A < B | 80 | 220 | 0.95 | 0.38 | 160 | 6 |
| | and D | | | | | | | |
| | M: Structure derived from | | | | | | | |
| | polycarbonate urethane | | | | | | | |
| | D: Structure derived from | | | | | | | |
| | polytetramethylene glycol | | | | | | | |

TABLE 6-2

| | | | | | | | Eval. 13 | | |
|---|---|---|---|---|---|---|---|---|---|
| | | | | | Eval. 11 | | Domain | Eval. 14 | |
| | Eval. 7 | Eval. 8 | Eval. 9 | Eval. 10 | Micro | Eval. 12 | cross- | Number | |
| Example | Formula | Formula | Formula | Formula | rubber | Nano | sectional | of | Eval. 15 |
| No. | (1) | (2) | (3) | (4) | hardness | indenter | area | domains | Circularity |
| 8 | 1.54 | 0.24 | 7.30 | 0.37 | 20 | 1.0 | 30% | 90% | 90% |
| 9 | 1.54 | 0.18 | 7.30 | 0.28 | 30 | 0.5 | 30% | 90% | 90% |
| 10 | 1.30 | 0.23 | 6.70 | 0.30 | 19 | 1.1 | 50% | 60% | 90% |
| 11 | 0.80 | 0.05 | 9.04 | 0.04 | 41 | 0.3 | 10% | 60% | 90% |
| 12 | 1.59 | 0.23 | 8.26 | 0.37 | 30 | 0.5 | 30% | 90% | 60% |
| 13 | 1.54 | 0.23 | 7.30 | 0.35 | 19 | 1.1 | 30% | 90% | 90% |

TABLE 7-1

| | Evaluation 1 | Eval. 2 | | | Eval. 3 | Eval. 4 | Eval. 5 | Eval. 6 |
|---|---|---|---|---|---|---|---|---|
| C.E. | Confirmation and analysis of | Relationship | | | Position | Elastic | Breaking | Permanent |
| No. | matrixes and domains | of AB | A | B | of CB | modulus | elongation | set |
| 1 | Clear phase separation of M | A > B | 170 | 90 | 0.92 | 0.40 | 120 | 12 |
| | and D | | | | | | | |
| | M: Structure derived from | | | | | | | |
| | PPG | | | | | | | |
| | D: Structure derived from | | | | | | | |
| | polycarbonate urethane | | | | | | | |
| 2 | Phase separation of M and D | A < B | 90 | 150 | 0.80 | 0.44 | 130 | 7 |
| | is unclear | | | | | | | |
| | M: Structure derived from | | | | | | | |
| | polycarbonate urethane | | | | | | | |
| | D: Structure derived from | | | | | | | |
| | PPG | | | | | | | |
| 3 | Clear phase separation of M | A > B | 310 | 210 | 1.00 | 3.20 | 90 | 4 |
| | and D | | | | | | | |
| | M: Structure derived from | | | | | | | |
| | polycarbonate urethane | | | | | | | |
| | D: Structure derived from | | | | | | | |
| | polymethylmethacrylate | | | | | | | |
| 4 | Clear phase separation of M | A < B | 90 | 170 | 0.74 | 0.44 | 140 | 6 |
| | and D | | | | | | | |
| | M: Structure derived from | | | | | | | |
| | polycarbonate urethane | | | | | | | |
| | D: Structure derived from | | | | | | | |
| | PPG | | | | | | | |

In the Tables 7-1 and 7-2, “C.E.” indicates “Comparative Example”.

TABLE 7-2

| | | | | | | | Eval. 13 | | |
|---|---|---|---|---|---|---|---|---|---|
| | | | | | Eval. 11 | | Domain | Eval. 14 | |
| | Eval. 7 | Eval. 8 | Eval. 9 | Eval. 10 | Micro | Eval. 12 | cross- | Number | |
| C.E. | Formula | Formula | Formula | Formula | rubber | Nano | sectional | of | Eval. 15 |
| No. | (1) | (2) | (3) | (4) | hardness | indenter | area | domains | Circularity |
| 1 | 1.06 | 0.33 | 8.30 | 0.35 | 17 | 4.5 | 45% | 60% | 90% |
| 2 | 1.22 | 0.35 | 8.18 | 0.43 | 20 | 2.7 | 45% | 70% | 60% |
| 3 | 0.30 | 0.49 | 8.00 | 0.15 | 59 | 0.6 | 50% | 90% | 90% |
| 4 | 0.30 | 0.38 | 9.18 | 0.11 | 24 | 1.0 | 45% | 70% | 90% |

The molded articles according to Examples 1 to 13 have a low elastic modulus, a large breaking elongation, and a small permanent set, and thus exhibited excellent mechanical characteristics as a sensor. In addition, a plurality of domains were dispersed in a matrix containing a urethane elastomer.

The parameter B indicating the viscoelastic term of the matrix was larger than the parameter A indicating the viscoelastic term of the domain, and the conductive agent was preferentially disposed in the matrix (that is, D/C≥0.90 was satisfied, and the conductive filler was localized in the matrix.). As a result, the resistance was changed by deformation, and a molded article exhibiting mechanical characteristics and electrical characteristics with high repeatability was obtained, which was suitable as a sensor.

In addition, Examples 1 to 5, 7 to 10, 12, and 13 also achieved Log₁₀(Ra)≤9.00, and were more suitable as sensors because of high sensitivity.

In addition, Examples 2 to 5 and 11 achieved Log₁₀(Rc)-Log₁₀(Ra)≤0.05, and exhibited very good resistance reproducibility.

Further, in Examples 3 and 5, the variation width of the resistance due to the deformation is large (Evaluation 7), and the resistance reproducibility at the time of unloading is high (Evaluation 8), and the sensor showed better characteristics.

On the other hand, in the molded articles according to Comparative Examples 1 and 3, the parameter A indicating the viscoelastic term of the domain is larger than the parameter B indicating the viscoelastic term of the matrix. As a result, the permanent set was increased, and the return rate of resistance at the time of unloading was also decreased.

The molded article according to Comparative Example 2 was mechanically phase-separated without passing through the polyether and the urethane reactive emulsifier to form a matrix domain structure. Thus, phase separation was obscured, resulting in a reduced return rate of resistance upon unloading.

In the molded article according to Comparative Example 4, the conductive filler was not localized in the matrix as compared with Example 1. Therefore, suitable electrical characteristics were not obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A molded article comprising:
a polyurethane elastomer; and
a conductive filler in the polyurethane elastomer, wherein
the polyurethane elastomer has a matrix and a plurality of domains dispersed in the matrix,
the conductive filler is localized in the matrix,
a relationship between a parameter A indicating a viscoelastic term of the domain and a parameter B indicating a viscoelastic term of the matrix, which are measured in a viscoelastic image by a scanning probe microscope of a cross section of the molded article where the domain and the matrix are exposed, is A<B,
an elastic modulus of the molded article at 50% tension at a temperature of 23° C. is 4.00 MPa or less, a breaking elongation of the molded article is 100% or more, and a tensile permanent set of the molded article after 50% tension is 10% or less, and
when a volume resistivity of the molded article with no strain is Ra (Ω·cm), a volume resistivity when the molded article is elongated by 50% is Rb (Ω·cm), and a volume resistivity when the tension applied to the molded article elongated by 50% is released is Rc (Ω·cm),
Ra, Rb, and Rc satisfy Formulas (1) and (2) below:
$${Log}_{10} ( Rb ) - {Log}_{10} ( Ra ) \geq 0.1 \qquad ( 1 )$$
$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

2. The molded article according to claim 1, wherein Ra satisfies Formula (3) below:
$${Log}_{10} ( Ra ) \leq 9. . \qquad ( 3 )$$

3. The molded article according to claim 1, wherein Ra and Rc satisfy Formula (4) below:
$${Log}_{10} ( Rc ) - {Log}_{10} ( Ra ) \leq 0.05 . \qquad ( 4 )$$

4. The molded article according to claim 1, wherein the molded article has a micro rubber hardness of 20 to 50 degrees at a temperature of 23° C., and
when a Vickers indenter is brought into contact with the matrix of the cross-section, the Vickers indenter is pushed at a load rate of 10 mN/30 seconds, the load is maintained at a load of 10 mN for 60 seconds, and then the load is unloaded, the strain after 5 seconds of unloading is 1.0 μm or less.

5. The molded article according to claim 1, wherein when observed with 50 μm square observation regions at three locations of the cross-section of the molded article, all three locations of the observation regions satisfy Requirements (2-1) and (2-2) below:
Requirement (2-1), The proportion of the total cross-sectional area of the domains in the observation region is 15% to 45%; and
Requirement (2-2), The proportion of the number of domains whose cross-sectional area is 0.1% to 13.0% of the area of the observation region is 70% by number or more.

6. The molded article according to claim 1, wherein, when observed with 50 μm square observation regions at three locations of the cross-section of the molded article,
the proportion of the number of domains having a circularity of 0.60 to 0.95 in the total number of domains is 70% by number or more.

7. The molded article according to claim 1, wherein the matrix has a polycarbonate structure represented by Formula (1) below as a first structure, and
the domains have a polyether structure represented by Formula (2) below as a second structure: 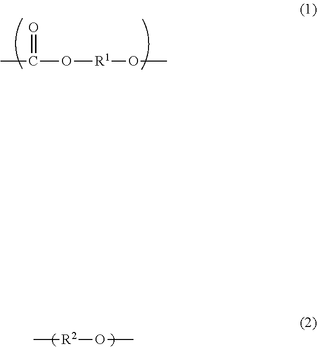
wherein, in Formula (1), R¹ represents an alkylene group having 3 to 9 carbon atoms, and in Formula (2), R² represents an alkylene group having 3 to 6 carbon atoms.

8. The molded article according to claim 1, wherein a ratio (A/B) of the parameter A to the parameter B is 0.65 or less.

9. An elastic body comprising:
a polyurethane elastomer; and
a conductive filler in the polyurethane elastomer, wherein
the polyurethane elastomer has a matrix and a plurality of domains dispersed in the matrix,
the conductive filler is localized in the matrix,
a relationship between a parameter A indicating a viscoelastic term of the domain and a parameter B indicating a viscoelastic term of the matrix, which are measured in a viscoelastic image by a scanning probe microscope of a cross section of the elastic body where the domain and the matrix are exposed, is A<B,
an elastic modulus of the elastic body at 50% tension at a temperature of 23° C. is 4.00 MPa or less, a breaking elongation of the elastic body is 100% or more, and a tensile permanent set of the elastic body after 50% tension is 10% or less, and
when a volume resistivity of the elastic body in no strain is Ra (Ω·cm), a volume resistivity when the elastic body is elongated by 50% is Rb (Ω·cm), and a volume resistivity when the tension applied to the elastic body elongated by 50% is released is Rc (Ω·cm),
Ra, Rb, and Rc satisfy Formulas (1) and (2) below:
$${Log}_{10} ( Rb ) - {Log}_{10} ( Ra ) \geq 0.1 \qquad ( 1 )$$
$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$

10. A strain sensor having a strain-sensitive portion whose volume resistivity varies depending on an amount of strain, wherein the strain-sensitive portion comprises a molded article comprising:
a polyurethane elastomer; and
a conductive filler in the polyurethane elastomer, wherein
the polyurethane elastomer has a matrix and a plurality of domains dispersed in the matrix,
the conductive filler is localized in the matrix,
a relationship between a parameter A indicating a viscoelastic term of the domain and a parameter B indicating a viscoelastic term of the matrix, which are measured in a viscoelastic image by a scanning probe microscope of a cross section of the molded article where the domain and the matrix are exposed, is A<B,
an elastic modulus of the molded article at 50% tension at a temperature of 23° C. is 4.00 MPa or less, a breaking elongation of the molded article is 100% or more, and a tensile permanent set of the molded article after 50% tension is 10% or less, and
when a volume resistivity of the molded article with no strain is Ra (Ω·cm), a volume resistivity when the molded article is elongated by 50% is Rb (Ω·cm), and a volume resistivity when the tension applied to the molded article elongated by 50% is released is Rc (Ω·cm),
Ra, Rb, and Rc satisfy Formulas (1) and (2) below:
$${Log}_{10} ( Rb ) - {Log}_{10} ( Ra ) \geq 0.1 \qquad ( 1 )$$
$$( {Log}_{10} ( Rc ) - {Log}_{10} ( Ra ) ) / ( {Log}_{10} ( Rb ) - {Log}_{10} ( Ra ) ) \leq 0.25 . \qquad ( 2 )$$
